(19) United States
(12) Patent Application Publication
(10) Pub. No.: US 2021/0011704 A1
(43) Pub. Date: Jan. 14, 2021

(54) PROGRESS MANAGEMENT SYSTEM, PROGRESS MANAGEMENT METHOD, AND INFORMATION PROCESSING APPARATUS

(71) Applicant: Ryuichi SAITO, Tokyo (JP)

(72) Inventor: Ryuichi SAITO, Tokyo (JP)

(73) Assignee: Ricoh Company, Ltd., Tokyo (JP)

(21) Appl. No.: 16/911,760

(22) Filed: Jun. 25, 2020

(30) Foreign Application Priority Data
Jul. 9, 2019 (JP) 2019-127970

(51) Int. Cl. G06F 8/65; H04L 29/08; G06F 9/48

(52) U.S. Cl. CPC G06F 8/65; G06F 9/4881; H04L 67/34

(57) ABSTRACT

A progress management system in which a plurality of progress management terminals that execute browser software and an information processing apparatus communicate with each other, terminals, the one of the progress management terminals sends an issue that the progress is updated to the information processing apparatus, and the information processing apparatus, when the issue that the progress is updated is received, reflects the issue that the progress is updated on other one or ones of the progress management terminals that display a same screen as that of the one of the progress management terminals using bidirectional communications, and browser software of the other one or ones of the progress management terminals automatically update the same screen as that of the one of the progress management terminals.

### CROSS-REFERENCE TO RELATED APPLICATIONS

The present application claims priority under 35 U.S.C. § 119 to Japanese Patent Application No. 2019-127970, filed Jul. 9, 2019. The contents of which are incorporated herein by reference in their entirety.

### BACKGROUND OF THE INVENTION

### 1. Field of the Invention

The present invention relates to a progress management system, a progress management method, and an information processing apparatus.

### 2. Description of the Related Art

It may be desirable for each of several progress managing persons in different locations to manage a series of tasks. In addition, by dividing the series of tasks among multiple progress managing persons, because the tasks are carried out simultaneously by multiple progress managing persons, it may be possible to shorten the time until the tasks are completed. It is desirable to manage the progress of the entire tasks if the multiple progress managing persons share the tasks.

Here, an information processing system has been devised in which each progress managing person inputs the end of a work from a progress management terminal and the progress status of the entire business is managed by the information processing apparatus, so that each progress managing person can grasp a progress situation of the entire task (for example, Japanese Laid-Open Patent Application No. 2017-107616).

### SUMMARY OF THE INVENTION

However, conventional technology has a problem that it is difficult to manage the progress of operations in real time with browser software. That is, Because the browser software operated by the progress management terminal of each progress managing person basically does not shift to the latest screen unless the user updates the screen, it is difficult to transmit the progress status to the other progress management terminal even if the information processing apparatus (server) receives the progress from one of the progress management terminals.

If a customer engineer or the like installs a dedicated program instead of a browser software on the progress management terminal, the latest information can be displayed without the user's operation. However, there is a disadvantage that the workload where the customer engineer or the like installs the dedicated program on the progress management terminal is large.

In view of the above-described problems, the present invention is intended to provide a progress management system that can manage the progress of operations in real time with browser software.

### Means for Solving Problems

According to the present disclosure, there is provided a progress management system in which a plurality of progress management terminals that execute browser software and an information processing apparatus communicate with each other, terminals, the one of the progress management terminals sends an issue that the progress is updated to the information processing apparatus, and the information processing apparatus, when the issue that the progress is updated is received, reflects the issue that the progress is updated on other one or ones of the progress management terminals that display a same screen as that of the one of the progress management terminals using bidirectional communications, and browser software of the other one or ones of the progress management terminals automatically update the same screen as that of the one of the progress management terminals.

### BRIEF DESCRIPTION OF DRAWINGS

FIG. 1 illustrates an example of an overall operation of a progress management system.

FIG. 2 illustrates a real-time management method for the progress of a task using browser software.

FIG. 3 illustrates a system structure of an example of a progress management system.

FIG. 4 illustrates an example of a hardware structure of a meeting management server.

FIG. 5 illustrates an example of a hardware structure of a meeting room terminal.

FIG. 6 is a function block diagram of an example of indicating functions of a reservation management server, a chat server, a meeting management server, a progress management terminal, and a registration terminal like blocks.

FIG. 7 is a functional block diagram illustrating the functions of a terminal device and a meeting room terminal like blocks.

FIG. 8 illustrates a relationship of screens operated by a managing person, a reservation person, or a progress managing person.

FIG. 9 is an example of a sequence diagram illustrating how a managing person sets up a reception workflow.

FIG. 10 illustrates an example of a workflow reception screen.

FIG. 11 illustrates an example of the visitor registration form screen.

FIG. 12 illustrates an example of the phase registration screen.

FIG. 13 is an example of a sequence diagram illustrating a procedure for registering visitor information by a reservation person.

FIG. 14 is a diagram illustrating an example of the text of an e-mail.

FIG. 15 illustrates an example of a visitor information registration screen.

FIG. 16 is an example of a sequence diagram explaining a procedure for managing the progress of the task by the progress management terminal in real time.

FIG. 17 is a diagram illustrating an example of a progress management screen.

FIG. 18 illustrates an example of the progress management screen that is updated when the phase of the reception workflow is depressed.

FIG. 19 is a diagram illustrating an example of a standby screen I displayed by a meeting room terminal when a meeting room is currently vacant;

FIG. 20 is a diagram illustrating an example of a standby screen II displayed by a meeting room terminal within a predetermined time until the next meeting starts when a meeting room is vacant.

FIG. 21 is a diagram illustrating an example of a standby screen III displayed by a meeting room terminal when a meeting room is during use.

FIG. 22 is an example of a sequence diagram explaining the procedure in which a progress managing screen of a progress management screen is updated when a participant operates a meeting room terminal.

FIG. 23 is a diagram illustrating an example of a progress management screen that is updated when a room entry button is depressed in a meeting room terminal.

FIG. 24 is a diagram illustrating an example of an operation rule selection screen displayed when the operation rule selection button is depressed.

FIG. 25 is a diagram illustrating an example of the progress screen displayed in a meeting room view.

FIG. 26 is a diagram illustrating an example of a relationship between color and the progress of a task.

FIG. 27 is a diagram illustrating a use case of a progress management system.

### DETAILED DESCRIPTION OF THE PREFERRED EMBODIMENTS

Hereinafter, as an example of an embodiment of the present invention, a progress management system and a progress management method performed by the progress management system will be described with reference to drawings.

### <Overview of Progress Management System>

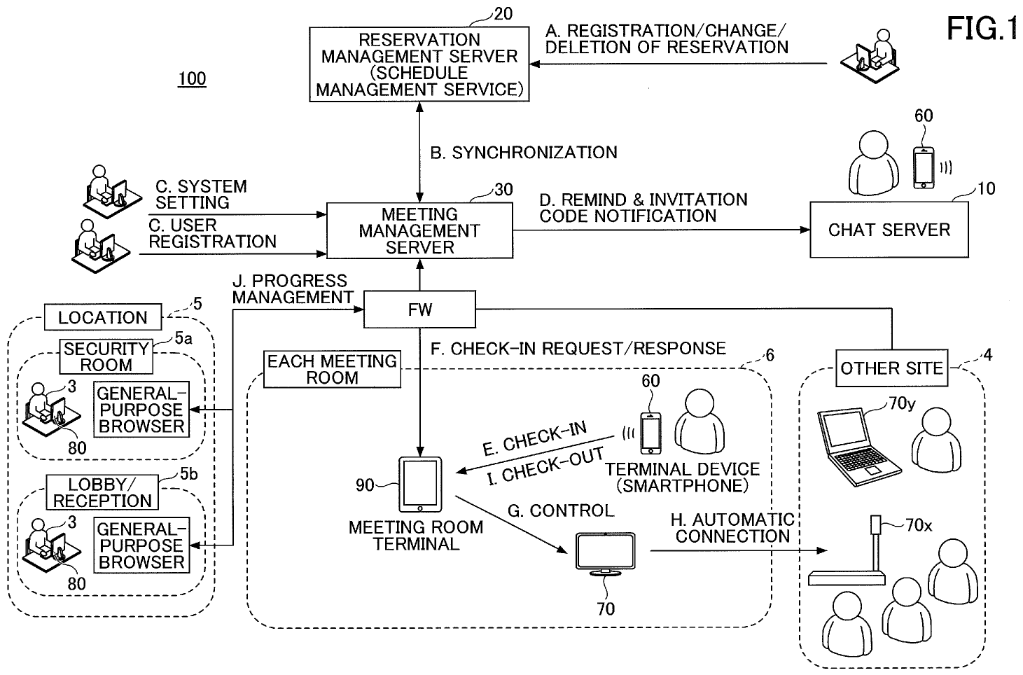

The outline of the progress management system is first described with reference to FIG. 1. FIG. 1 is an example of a diagram illustrating the overall operation of the progress management system 100.

A. The reservation person operates the own terminal device 60 to communicate with the reservation management server 20 and reserves a meeting room. The reservation management server 20 is a general-purpose cloud service (Office 365, G Suite (“Office 365” and “G Suite” are registered trademarks, etc.), but the meeting room owned by a company, to which the reservation person belongs, is registered.

B. The meeting management server 30 is a server that controls the entire progress management system 100 based on a reservation status of the meeting room. Because the meeting management server 30 appropriately communicates with the reThe managing person or the like on the organizational side using the progress management system 100 may operate the registration terminal 50 to register a user and perform various settings to the meeting management server 30.

The user registration means to register an ID or mail address that identifies an individual user of the progress management system 100 with the meeting management server 30. As an example, this means registering a user who is subject to various notifications using a chat server 10 (slack, Line, Microsoft Teams, etc., “slack”, “Line”, and “Microsoft Teams” are registered trademarks). Because the notification is performed by a bot sending a message as the meeting management server 30, the bot provided by the chat server is also registered.

The bot is a program for providing the user with an interface for receiving various notifications and inputs as a proxy for the progress management system and the meeting management server 30 on each chat application (a terminal application of a chat system) in a terminal such as a smartphone possessed by each user.

The bot is a program on the chat server 10. As a virtual chat partner, the bot communicates with a user (a user of the progress management system) and performs notification, input reception, various guidance, and the like. For example, the progress management system can be used as a point of contact for the system, such as notifying the user of a reminder of reservation information, and accepting the user's input, such as participation in a meeting or non-participation in the reminder, as a chat. Various settings include registering the meeting room terminal 90 and setting the timing of reminders.

Further, the managing person, etc. operates the registration terminal 50 to set the reception workflow and the visitor registration form for each operation rule or each meeting room to the meeting management server 30.

The reception workflow is listed up by the managing person of each phase of the tasks managed by the progress managing person with respect to the reception of the reserved meeting room.

The visitor registration form means a form (an entry field) on which a reservation person registers visitor information for a meeting reserved by the reservation person.

D. The meeting management server 30 reminds the reservation person of the holding of the meeting at a predetermined time prior to the start time of the meeting in the reservation information.

This will reduce an undone reservation in meeting rooms. The meeting management server 30 notifies the user of an invitation code (invitation to a group) as necessary. The meeting reservation person saves, in the terminal device 60, information (meeting identification information) for checking in to the meeting room by receiving a reminder.

The check-in is a process of inputting an instruction for a check-in used by the user in the meeting room and processing in which the meeting management server 30 receives information indicating a check-in in response to an instruction for a check-in and sets a start flag indicating the start of use of a predetermined meeting room.

E. Each meeting room terminal 90 is provided with the meeting room terminal 90, which downloads the reservation information of the meetings to be held in this meeting room on a regular basis.

The meeting room terminal 90 may display a schedule for the day or the latest meeting to allow delegates to confirm the meeting's schedule. Shortly before the start time of the meeting, the reservation person of the meeting room goes to meeting room 6 and checks in. For example, the meeting room identification information is input into the meeting room terminal 90, or the terminal device 60 is brought closer to the meeting room terminal 90 (such as having the user read the meeting room identification information, causing the user to communicate, or having the user depress a check-in button (a use start button) displayed by the terminal app 90a of the meeting room terminal 90).

F. Because the meeting room terminal 90 sends a check-in request to the meeting management server 30, if the check-in can be authenticated by the meeting identification information, a response indicating that the check-in can be completed is received from the meeting management server 30. The meeting room terminal 90 indicates that it is during use (during the meeting).

If it is impossible to confirm a use start notification notifying the check-in until a predetermined time relative to the start time of the meeting, the meeting management server 30 cancels the reservation of the meeting room 6 (cancels the reservation information when the meeting room is not started to be used for a predetermined time) and sends a status indicating that the cancellation is done contained in the reservation information to the meeting room terminal 90. In this case, because the meeting room terminal 90 indicates that it is a vacant room, an arbitrary user can use the meeting room 6.

G. Meeting room terminal 90 controls the electronic device 70 upon request from the meeting management server 30.

For example, the power is turned on at the start time of the meeting and is turned off at the end time of the meeting. This will improve the convenience of meeting participants in operating the electronic device 70.

H. If the electronic device 70 has a teleconference function, for example, it can communicate with the electronic device (e.g., the teleconference terminal 70x) of other site 4 and hold a meeting with the other site.

Further, the PC 70y for which the app operates can communicate with the electronic device 70. The reservation information includes the destination information (the communication ID of the destination) representing the other site 4 in advance, and the electronic device 70 can communicate with the teleconference terminal 70x and the PC 70y automatically.

When the reservation person ends the meeting, the button of the meeting room terminal 90 is depressed to check out, so the meeting room terminal 90 displays the next reservation status. This allows an arbitrary user to know the reservation status of the meeting room.

J. Participants (reservation person, visitor, etc.) go to the meeting room after lending a meeting room card, etc. in a place where they ought to visit in advance to use the meeting room (hereinafter, referred to as Location 5). For example, a nameplate indicating the visitor, a ticket stamped with the visit time and the employee's signature, an IC card for security clearance, a meeting room key, and so on.

A security room 5a is a location for the visitor to stop by and a lobby/reception 5b is a location for the visitor or employee to stop by. How to call these names differs for different compactness and is just one example.

There may be only one of the security room 5a and the lobby/reception 5b, and how to call is not limited thereto. For example, the meeting participant may visit a general affairs clerk or a shop in each floor.

The person who manages the progress of the task in the security room 5a or the lobby/reception 5b is referred to as a progress managing person 3. The progress managing person 3 operates the progress management terminal 80 to display the progress management screen including the reception workflow acquired from the meeting management server 30, and inputs the progress of the task related to the use of the meeting room into the progress management screen. Browser software operates in the progress management terminal 80.

For example, when the progress managing person 3 of the security room 5a updates the progress of the task related to the use of the meeting room, the content of the updating is sent to the meeting management server 30 and reflected on the progress management screen displayed by the progress management terminal 80 of the lobby/reception 5b in real time. Further, the operation to the meeting room terminal 90 is reflected in the progress management screen.

### <Outline of Real-Time Management of Progress of Task Using Browser Software>

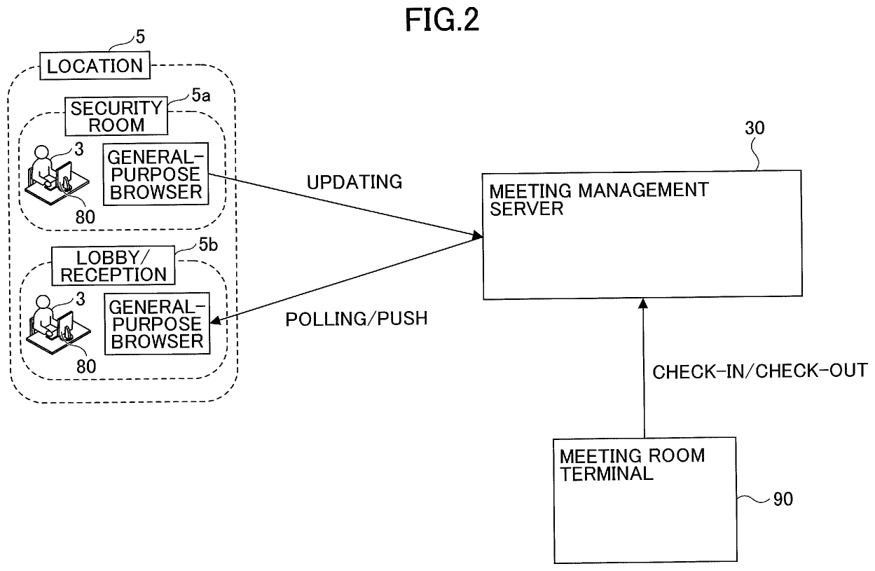

FIG. 2 illustrates a schematic diagram of a real-time management method for the progress of the task by browser software according to the present embodiment. Although the browser software operates in the meeting room terminal 90, the browser software basically does not move to the latest screen unless the user updates the screen.

Therefore, for example, even if the progress managing person 3 of the security room 5a updates the progress of the operation on the progress management screen (reception workflow), it was difficult for the progress management terminal 80 of the lobby/reception 5b to reflect the progress of the operation on the progress management screen in real time.

Accordingly, according to the present embodiment, the progress management terminal 80 (the other progress management terminal) of the lobby/reception 5b inquires whether there is any progress of the operation by polling, and when there is any progress, the meeting management server 30 sends the progress contents to the progress management terminal 80 of the lobby/reception 5b. Alternatively, when there is a progress in the business, the meeting management server 30 pushes the progress contents to the progress management terminal 80 of the lobby/reception 5b.

In this way, even though the progress management terminal 80 of the security room 5a and the lobby/reception terminal 5b uses the browser software, the security room 5a and the progress management terminal 80 of the lobby/reception terminal 5b can mutually reflect the progress of the task on the progress management screen in real time.

Similarly, the meeting room terminal 90 may be reflected to the progress management terminal 80 when the participant operates. For example, when a participant checks in to the meeting room, the checked in is registered with the meeting management server 30. The progress management terminal 80 of each location 5 can reflect the progress of the task (in this case, check-in) in real time on the progress management screen by polling or push-in communication.

### <Terminology>

Browser software is software used to read the content of data and files. In particular, the browser software refers to the display of data and files on the Internet.

The progress means a matter is in progress or degree of the progress in the matter.

A bi-directional communication is a mode of communication in which devices inside and outside the firewall can initiate communication with each other. In this embodiment, the term polling or push communication is used.

A resource is an asset. The meeting room and the facility, facility, people (reception) and structure that can be used in the meeting room can be resources. The resource that is relatively difficult to move is called a facility. For convenience of illustration, the term meeting room is used in this embodiment as an example of resource.

### <Example of System Structure>

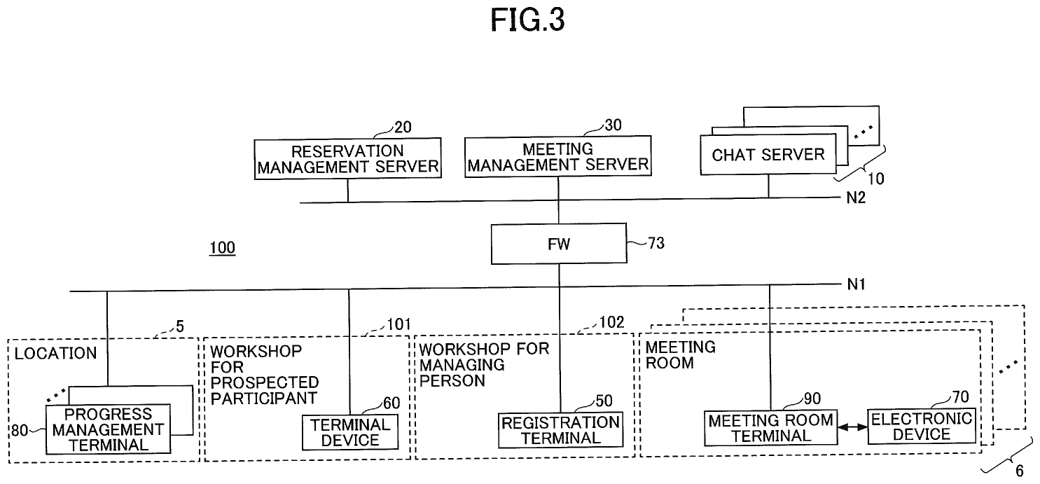

FIG. 3 is a system structure on an example of the progress management system 100. The progress management system 100 may be divided into an external network N2 and an internal network N1. The internal network N1 refers to the network inside the firewall 73, and external network N2 refers to a network such as the Internet where an unspecified number of communications is sent.

The reservation management server 20, the meeting management server 30, and the at least one chat servers 10 are connected to the external network N2, and each server can communicate as needed. The external network N2 may be connected to the terminal device 60 operated by the participant in the meeting as needed.

The reservation management server 20 is implemented by at least one information processing apparatus (computer system) mounted on an ordinary OS or the like. The system related to the reservation of a facility provided by the reservation management server 20 is referred to as the reservation management system. The reservation management server 20 has a calendar system and provides a web application for managing various schedules.
Specifically, it has the following functions.
   Receiving of registration of the reservation and an arbitrary confirmation by the reservation person
   By email at the set date and time, such as 30 minutes before the scheduled date.
   One person can manage reservations in multiple calendars (for work, home, etc.).
   Share calendars with people in the same group
The reservation management server 20 manages the user using an account.

The account is a user's right to use a service. In many systems, the user logs into the system using the account. For this reason, the account has a function (identification information function) that uniquely identifies the user of the system. According to the present embodiment, the reservation management server 20 sends the reservation information of the previously registered account (domain) to the meeting management server 30.

Alternatively, when the meeting management server 30 requests the reservation information by designating the account of the reservation management server 20, the meeting management server 30 can acquire the reservation information of the meeting room 6 from the reservation management server 20. The account may be information that uniquely identifies the user, for example, e-mail, ID, telephone number, or the like.

According to the present embodiment, the scheduled reservation is managed in the meeting room 6, but the reservation management server 20 is not limited to the meeting room 6 and can manage various schedules. In addition to the meeting room 6, it can be used for reservation of various facilities such as rental offices, rental studios, rental cycles, lodging facilities such as rental cars and hotels, and rental spaces such as event venues and lockers.

As the reservation management system including the reservation management server 20 and the reservation management server, the G Suite (“G Suite” is a registered trademark) and the Office 365 (“Office 365” is a registered trademark) are known, but the reservation management system having the function described in this embodiment is sufficient.

Further, in the present embodiment, information concerning the meeting room 6 of the internal network N1 is pre-registered in the reservation management server 20. That is, the web application of the reservation management server 20 is customized according to the meeting room name of each meeting room 6 in an internal network of a company using the progress management system 100, the meeting room ID, the reservation time, the capacity of each meeting room 6, and the reservation unit, etc. Accordingly, reservation information is associated with the meeting room 6 of the company using the progress management system 100.

The chat server 10 may be implemented by one or more information processing apparatuses (computer systems) having a typical server OS or the like. The chat system is a real-time sharing system for information such as text, audio, video and the like among a plurality of users provided by the chat server 10.

The chat server 10 notifies the terminal device 60 of the information regarding the reservation of the meeting room 6. In this embodiment, a plurality of chat servers 10 having different operating entities may be included.

The shared information includes images, audio, etc., and is not limited to text. However, for the sake of convenience of explanation, the present embodiment explains that text is mainly used for the notification. For example, the chat system may provide a voice call function between groups. A voice call may be one-to-one or one-to-N (≥2). Accordingly, in this embodiment, when the chat system notifies the information regarding the reservation of the meeting room 6, it may output an audio message as well as a text display. The chat system is known as LINE (“LINE” is a registered trademark; hereinafter abbreviated), slack (“slack” is a registered trademark), and Microsoft Teams (“Microsoft Teams” is a registered trademark; hereinafter abbreviated). However, the chat system may be sufficient to notify one or more users of a bot (a program that performs predetermined processing).

The chat server 10 similarly manages the user with the account (different from the account of the reservation management server 20), but in principle, the meeting management server 30 does not need to be aware of the account of the chat server 10. However, the meeting management server 30 may designate and notify any account of the chat server 10.

The meeting management server 30 can be implemented by one or more information processing apparatuses (computer systems) having an ordinary server OS or the like (an example of an information processing apparatus according to the claims). As processing related to the external network N2, the meeting management server 30 acquires the reservation information of the meeting room 6 from the reservation management server 20, acquires an prospected participant set as the reservation information, and sends a notification to a group (or an individual person such as a reservation person) of the chat server 10 associated with the prospected participant at a predetermined time.

Further, as processing related to the internal network N1, the check-in and the check-out to and from the meeting room 6 are managed, and the power supply of the electronic device 70 is controlled based on the reservation information of the meeting room 6 acquired from the reservation management server 20.

The internal network N1 is used in the meeting room 6, the workshop 101 for prospected participant, the workshop 102 for managing person, and the location 5. The prospected participants can access the external network N2 from each location via the internal network N1. The internal network N1 is, for example, a local area network (LAN).

The meeting room 6, the workshop 101 for prospected participant, and the workshop 102 for managing person are not necessarily LANs within the same enterprise.

A meeting room terminal 90 and an electronic device 70 are disposed in the meeting room 6. The meeting room terminal 90 and the electronic device 70 may communicate over a small LAN or dedicated line. The electronic device can be connected to the internal network N1 and the external network N2 without going through the meeting room terminal 90. The meeting room terminal 90 and the electronic device 70 may communicate using a wireless or wired communication. Because the internal network N1 is present inside the firewall 73, a direct communication from the external network N2 to the internal network N1 is difficult.

The meeting room terminal 90 is an information processing terminal operated by a participant of the meeting such as a reservation person who uses the meeting room 6. The meeting room terminal 90 is disposed on the desk of the meeting room 6 or at the entrance of the meeting room 6. A plurality of meeting room terminals 90 may be disposed in one meeting room 6. The meeting room terminal 90 can be substantialized by one or more information processing apparatuses (computer systems) having an ordinary OS or the like.

The meeting room terminal 90 sends the meeting room ID to the meeting management server 30 and displays the reservation information of the meeting room 6 on the day. In addition, the reservation information is requested periodically to acquire the reservation information that has been changed. Further, the control information such as the power ON and OFF of the electronic device 70 is acquired from the meeting management server 30. Thus, the meeting room terminal 90 turns ON and OFF the power of the electronic device 70.

The meeting room terminal 90 displays a standby screen for check-in, check-out, or the like, and communicates with the meeting management server 30 for informing the meeting management server 30 of the check-in or check-out. At the time of check-in, the meeting room terminal 90 sends the meeting identification information input from the reservation person and the meeting room ID stored in advance to the meeting management server 30. Therefore, the meeting management server 30 can confirm that the meeting room 6 reserved by the reservation person who has reserved the meeting room 6 is used based on the meeting identification information and the meeting room ID.

The electronic device 70 is a variety of office equipment that may be used in the meeting room 6. Examples thereof include an electronic chalkboard, multifunction peripheral, digital signage, digital cameras and the like. The electronic blackboard has a large display with a touch panel, detects the coordinate of the panel indicated by the user, connects the coordinates, and displays a stroke. In addition, the image of the connected PC can be displayed, and the stroke can be synchronized by communicating with the electronic blackboard in other sites. Incidentally, an electronic blackboard may be called an electronic information board or an electronic whiteboard.

The multifunction peripheral has functions of a copier, scanner, printer, and facsimile transmission/reception machine, and may be used for printing materials during meetings, copying materials, digitizing materials, and transmitting materials. A projector is a projector for projecting images. For example, the terminal device 60 can share the image displayed on the display by projecting the image on the screen or the like among the participants. A digital signage is a large display and is used to display any still image or movie. Digital cameras are used by each participant to capture and store paper or electronic material displayed on the electronic blackboard.

A terminal device 60 is capable of connecting to the internal network N1 and is disposed in the workshop 101 for prospected participant. The terminal device 60 may communicate by a wired or wireless communication. The terminal device 60 is an information processing apparatus used by a prospected participant (including the reservation person) when reserving the meeting room, but it is also assumed that the terminal device 60 is brought into the meeting room. The terminal device 60 is an information processing apparatus carried by a prospected participant.

The terminal device 60 can be implemented by one or more information processing apparatuses (computer system) in which an ordinary OS or the like is installed. The terminal device 60 may be, for example, a smartphone, a tablet terminal, a PC (Personal Computer), a PDA (Personal Digital Assistant), a wearable PC (a sunglass-type, wristwatch-type, etc.), or the like. However, the terminal device 60 is sufficient to have communication function and dedicated application software operating the chat server 10 or the reservation management server 20. For example, a car navigation system, a game machine, a television set, or the like may also be the terminal device 60.

In the terminal device 60, the application software (hereinafter, referred to as “chat application”) dedicated to the chat server 10 is operated, and further application software dedicated to the progress management system 100 (hereinafter, referred to as “meeting application”) is operated. However, these may be substituted with browser software.

The workshop 102 for managing person has a registration terminal 50 that can be connected to the internal network N1. The registration terminal 50 may communicate by the wired or wireless communication. The registration terminal 50 is a terminal for the managing person to perform various settings in the meeting management server 30.

The registration terminal 50 may be an information processing apparatus similar to the terminal device 60. However, because it is mainly used for setting the managing person in the meeting management server 30, there may be no chat application or meeting application.

The registration terminal 50 communicates with the meeting management server 30 mainly by browser software and displays a web page. The registration terminal 50 functions as a display unit (a first display unit of the meeting management server 30. The display unit for displaying a screen provided by the meeting management server 30 may be a display unit directly connected to the meeting management server 30 or a display unit provided to a server apparatus itself.

A plurality of progress management terminals 80 capable of connecting to the internal network N1 are disposed in the location 5. The progress management terminal 80 may communicate by the wired or wireless communication. The progress management terminal 80 is a terminal for the progress managing person 3 to update the reception workflow. Because the progress of the task in the progress management screen is shared by the progress management terminal 80 of each location 5, each progress managing person 3 can manage the progress of the task in connection with the reception of the same meeting room.

The progress management terminal 80 may be an information processing apparatus similar to the terminal device 60. However, the progress management terminal 80 primarily communicates with the meeting management server 30 by browser software and displays a web page. This web page is sometimes called a screen. The web page is provided by a web application. The web app refers to software or a mechanism that runs on the browser by cooperating between programs in a programming language (e.g., JavaScript (“JavaScript” is a registered trademark)) and programs on the web server. The web page can be changed dynamically by the web application.

The display unit for displaying the screen provided by the meeting management server 30 may be a display unit directly connected to the meeting management server 30 or the display unit provided on the server apparatus itself.

### <Hardware Structure>

### «Hardware Structure of the Meeting Management Server»

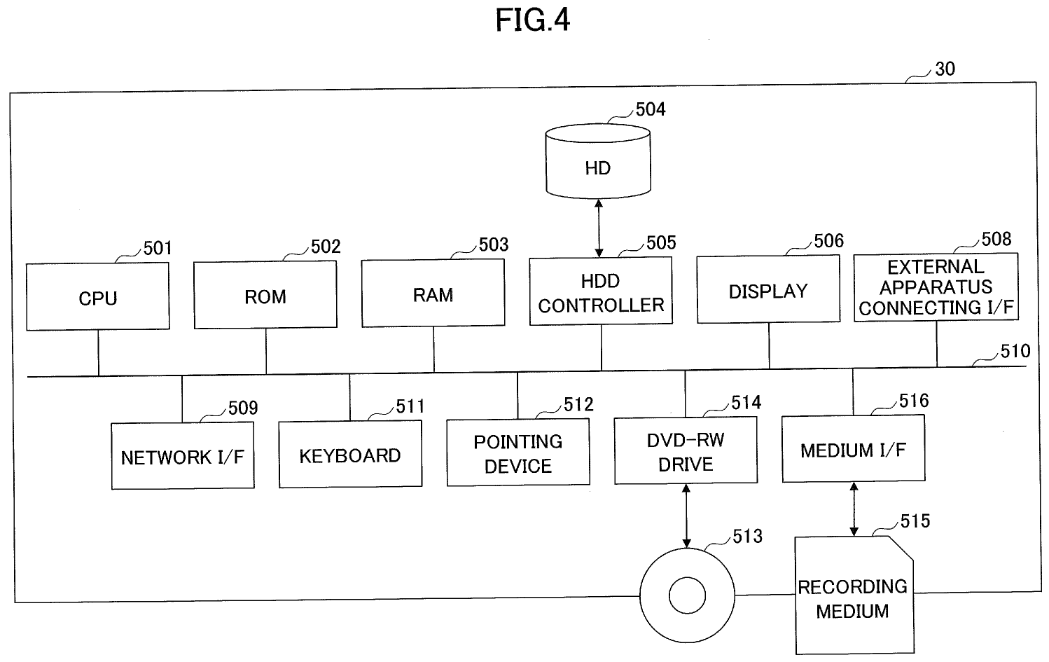

FIG. 4 illustrates an example of a hardware structure of the meeting management server 30. As illustrated in FIG. 4, the meeting management server 30 is formed by a computer and includes a CPU 501, ROM 502, RAM 503, HD 504, HDD (hard disk drive) controller 505, display 506, external apparatus connection I/F (interface) 508, network I/F 509, bus line 510, keyboard 511, pointing device 512, DVD-RW (Digital Versatile Disk Rewritable) drive 514, and media I/F 516.

From among these, the CPU 501 controls the operation of the entire meeting management server 30. The ROM 502 stores a program used to drive the CPU 501, such as an IPL. RAM 503 is used as the work area of CPU 501. The HD 504 stores various data such as a program. The HDD controller 505 controls reading or writing of various data to the HD 504 according to the control of the CPU 501. The display 506 displays various information such as cursors, menus, windows, characters, or images. The external apparatus connection I/F 508 is an interface for connecting various external apparatus. In this case, the external apparatus may be, for example, a USB (Universal Serial Bus) memory or a printer. The network I/F 509 is an interface for performing data communication using a communication network. The bus line 510 is an address bus, a data bus, or the like for electrically connecting components such as the CPU 501 illustrated in FIG. 4.

The keyboard 511 is also a type of input unit having a plurality of keys for input of characters, numbers, various instructions, and the like. The pointing device 512 is a type of input unit for selecting and executing various instructions, selecting a processing target, moving a cursor, and the like. The DVD-RW drive 514 controls the reading or writing of various data to the DVD-RW 513 as an example of a removable recording medium. It is not limited to DVD-RW, but may be DVD-R, etc. The media I/F 516 controls the reading or writing (storage) of data to a recording medium 515, such as a flash memory.

### «Meeting Room Terminal»

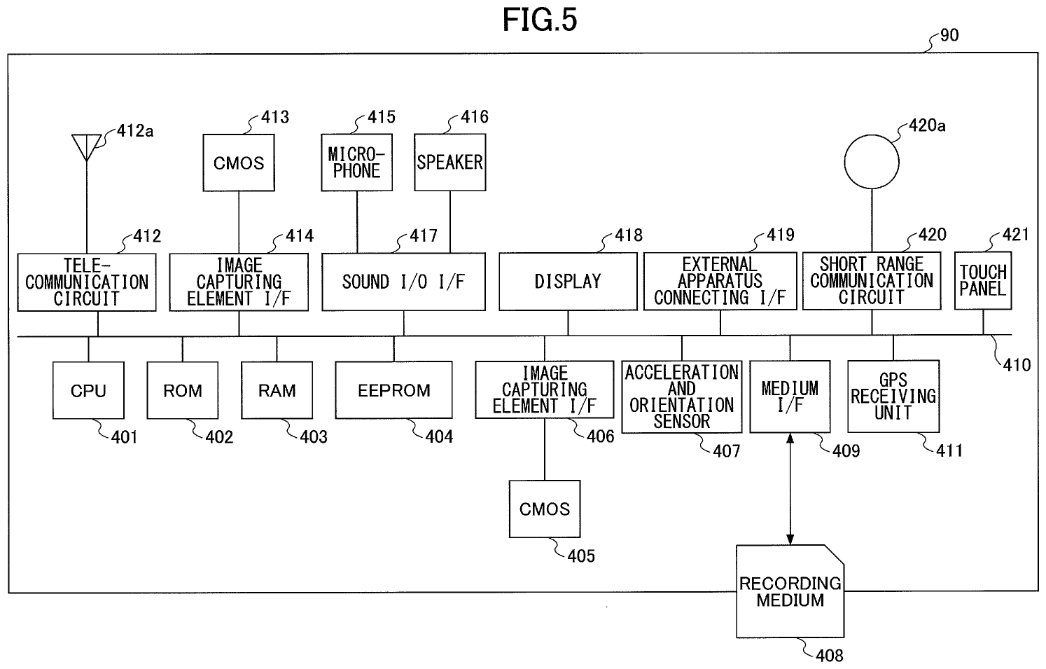

FIG. 5 illustrates a hardware structure of an example of the meeting room terminal 90. Incidentally, the meeting room terminal 90 of FIG. 5 is assumed to be a tablet device. As illustrated in FIG. 5, the meeting room terminal 90 includes a CPU 401, a ROM 402, a RAM 403, an EEPROM 404, a CMOS sensor 405, an image capturing element I/F 406, an acceleration and orientation sensor 407, a media I/F 409, and a GPS receiving unit 411.

From among these, the CPU 401 controls the operation of the entire meeting room terminal 90. The ROM 402 stores a program used to drive the CPU 401, such as the CPU 401 and the IPL. RAM 403 is used as the work area of CPU 401. The EEPROM 404 reads out or writes various data such as a smartphone program according to the control of the CPU 401. The CMOS (Complementary Metal Oxide Semiconductor) sensor 405 is a type of built-in imaging means that captures a subject (mainly a self-image) according to the control of the CPU 401 to acquire image data.

It may be an imaging means, such as a CCD (Charge Coupled Device) sensor, not a CMOS sensor. The image capturing element I/F 406 is a circuit that controls to drive the CMOS sensor 405. The acceleration and orientation sensor 407 is a variety of sensors, such as an electromagnetic compass, a gyrocompass, and an acceleration sensor, which detect geomagnetic fields.

The media I/F 409 controls the reading or writing (storage) of data to a recording medium 408, such as a flash memory. The GPS receiving unit 411 receives the GPS signal from the GPS satellite.

The meeting room terminal 90 includes a telecommunication circuit 412, a CMOS sensor 413, an image capturing element I/F 414, a microphone 415, a speaker 416, a sound input/output I/F 417, a display 418, an external apparatus connection I/F (Interface) 419, a short range communication circuit 420, an antenna 420a of the near range communication circuit 420, and a touch panel 421.

From among these, the telecommunication circuit 412 is a circuit for communicating with another apparatus via a communication network. The CMOS sensor 413 is a kind of a built-in type image capturing unit that captures a subject according to a control of the CPU 401 and acquires image data. The image capturing element I/F 414 is a circuit that controls the drive of the CMOS sensor 413. The microphone 415 is a built-in circuit that converts sound to an electrical signal. The speaker 416 is a built-in circuit that converts an electrical signal to physical vibrations to produce sound, such as music and speech. The sound input/output I/F 417 is a circuit that processes a sound signal between the microphone 415 and the speaker 416 according to the control of the CPU 401.

The display 418 is a type of display unit such as a liquid crystal or an organic EL (Electro Luminescence) for displaying an image of a subject or various icons. The external apparatus connection I/F 419 is an interface for connecting various external apparatus. The shortrange communication circuit 420 is a communication circuit such as a Near Field Communication (NFC) or Bluetooth (“Bluetooth” is a registered trademark). The touch panel 421 is a type of input unit for operating the meeting room terminal 90 by the user depressing on the display 418.

The meeting room terminal 90 also includes a bus line 410. The bus line 410 is an address bus, data bus, or the like for electrically connecting components such as the CPU 401 illustrated in FIG. 5.

### <Function>

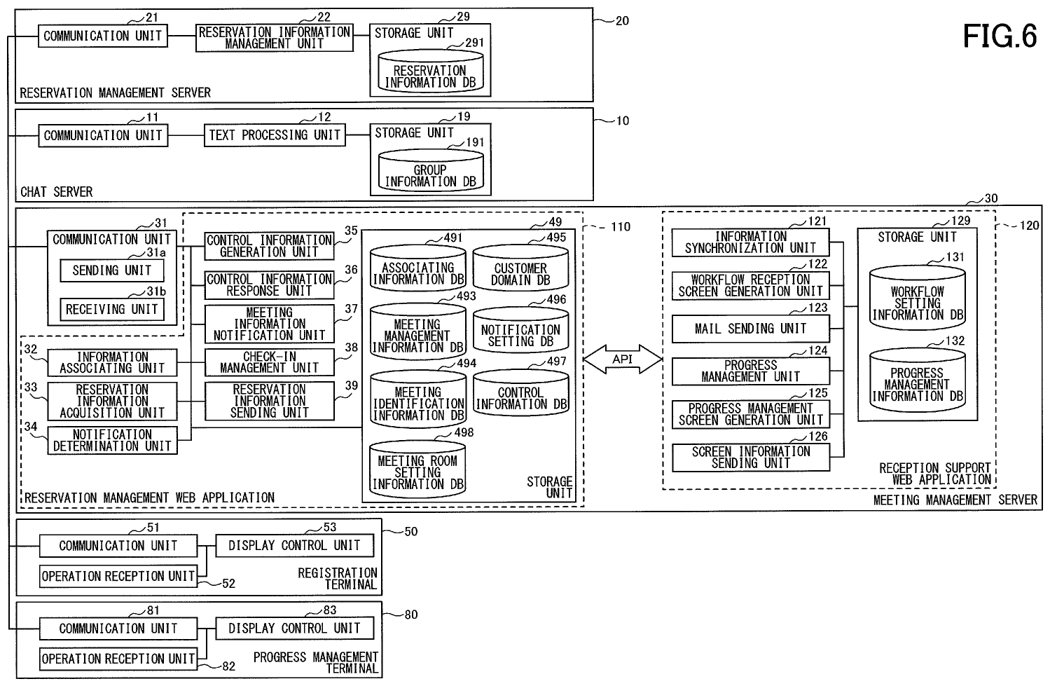

FIG. 6 is a functional block diagram illustrating the functions of the reservation management server 20, the chat server 10, the meeting management server 30, the progress management terminal 80, and the registration terminal 50 like a block.

«Reservation management server»

The reservation management server 20 includes a communication unit 21 and a reservation information management unit 22. Each of these function units provided by the reservation management server 20 is a function or unit implemented by one of the components illustrated in FIG. 4 operating in accordance with a command from the CPU 501 according to a program deployed from the HD 504 to the RAM 503.

The communication unit 21 sends and receives various information with the meeting management server 30 and the terminal device 60. The communication unit 21 sends screen information of the reservation setting screen to the terminal device 60 and receives the reservation setting from the terminal device 60. The reservation information is sent to the meeting management server 30.

The reservation information management unit 22 is an ordinary web server (web application) that receives reservation information, and further manages reservation information registered by the user. When the reservation information is registered (or changed), the reservation information management unit 22 notifies the meeting management server 30 of the account of the reservation person and sends the reservation information to the meeting management server 30 through the communication unit 21 in response to a request for designating an account from the meeting management server 30. The reservation information that has been changed without a request may be sent to the meeting management server 30. An ordinary web application is to be used as the method by which the reservation management server 20 reserves meeting room 6.

The reservation management server 20 includes a storage unit 29. The storage unit 29 is implemented by the RAM 503, the HD 504, or the like of FIG. 4. Reservation information DB 291 (Data Base) is stored in the storage unit 29.

TABLE 1
RESERVATION INFORMATION DB

| | RESERVATION | | | | | PROSPECTIVE |
|---|---|---|---|---|---|---|
| RESERVATION | PERSON | MEETING | MEETING | START | END | PARTICIPANT |
| ID | ACCOUNT | ROOM NAME | ROOM ID | TIME | TIME | ACCOUNT |
| 001 | a@xfood.com | COMMERCIAL | K-001 | 2017/07/07 | 2017/07/07 | b@xfood.com |
| | | PRODUCT Z | | 10:00 | 12:00 | c@xfood.com |
| | | DEVELOPMENT | | | | d@xfood.com |
| | | MEETING | | | | |
| 002 | e@xfood.com | COMMERCIAL | K-001 | 2017/07/07 | 2017/07/07 | f@xfood.com |
| | | PRODUCT Y | | 13:00 | 14:00 | g@xfood.com |
| | | DEVELOPMENT | | | | |
| | | MEETING | | | | |
| . . . | . . . | . . . | . . . | . . . | . . . | . . . |

Table 1 shows an example of reservation information stored in the reservation information DB 291. The reservation information is information to manage the reservation status of meeting room 6. In the reservation information, if a reservation person account, meeting name, meeting room ID, start time, end time, and prospected participant account corresponding to the reservation ID. A reserved ID is identification information that identifies one record of reserved information. The ID stands for Identification and means identifier or identification information. The ID is a name, code, character string, numeric value, or one or more of these combinations used to uniquely distinguish a particular object from multiple objects.

The same applies to IDs other than reserved IDs. The reservation account is the account of the prospected participant who reserved a meeting room 6. The name of the meeting is the name given to the prospected participant voluntarily. The Meeting Room ID is the identification information identifying the meeting room 6 in the internal network. The start time is the start time of the scheduled meeting room 6 (the start time of the meeting), and end time is the end time of the scheduled meeting room 6 (the end time of the meeting). The prospected participant account is the account of the prospected participant who is scheduled to attend the meeting. All of the accounts in Table 1 are accounts issued by the reservation management server 20.

### «Chat Server»

The chat server 10 includes a communication unit 11 and a text processing unit 12. Each of these function units of the chat server 10 is a function or unit implemented in which each of the structure categories illustrated in FIG. 4 is operated by a command from the CPU 501 according to a program expanded from the HD 504 to the RAM 503.

The communication unit 11 sends and receives various information from the meeting management server 30. In this embodiment, information about the meeting room reservation, information identifying a bot (e.g., a token), and information identifying the group of the notification destination are received from the meeting management server 30. The information identifying the bot is notified in advance by the chat server 10 as the bot identification information when the bot of the meeting management server 30 is created.

In addition, an individual account, such as the reservation person, may be specified. The communication unit 11 sends an issue that the prospected participant has read the information concerning the meeting room reservation or a response of the prospected participant to the meeting management server 30 in response to the information concerning the displayed meeting room reservation.

The text processing unit 12 sends information related to the reservation of the meeting room 6 to the prospected participants belonging to the group based on the information identifying the bot notified from the meeting management server 30 and the information identifying the group to which the notification is made. The notification may be made only for the number of prospected participants or only for the reservation person or the users on the notification destination.

The text processing unit 12 can provide a so-called push notification. The push notification uses a well-known mechanism provided by each operating system.

The chat server 10 includes a storage unit 19. The storage unit 19 is implemented by the RAM 503, the HD 504, or the like of FIG. 4. The group information DB 191 is stored in the storage unit 19.

TABLE 2
GROUP INFORMATION DB

| | | MEMBER | MEMBER | MEMBER | MEMBER | |
|---|---|---|---|---|---|---|
| WORKSPACE | CHANNEL | ACCOUNT 1 | ACCOUNT 2 | ACCOUNT 3 | ACCOUNT 4 | BOT ACCOUNT |
| http://sample.com/1 | #marketing | a@chat.com | b@chat.com | c@chat.com | d@chat.com | robo@chat.com |
| http://sample.com/2 | #team1 | b@chat.com | d@chat.com | | | |
| http://sample.com/3 | #ip | f@chat.com | g@chat.com | h@chat.com | | robo@chat.com |
| . . . | . . . | . . . | . . . | . . . | . . . | . . . |

Table 2 shows an example of group information stored in group information DB 191. The group information is information in which the accounts of members belonging to the same group are registered. The group information includes member accounts 1 to n (n=4 in Table 2) and bot accounts in association with the workspaces and channels.

The workspaces are identification information to identify organizations such as companies and departments. In this embodiment, multiple members belong to the workspace (e.g., Company A). The workspace is, for example, a URL, which is sufficient to be unique. In addition, the workspace has multiple channels depending on the purpose of the chat and the like. The channel is a group of members for which common information is exchanged, e.g., a group for Product A, a group for Product B, etc. Any one of the members belonging to the workspace belongs to the channel. That is, the notification destination is identified by the workspace and the channel.

However, because a method of identifying the notification destination differs depending on a chat system, if there is present the identification information that can uniquely identify the group, this identification may be done using only the information or three pieces or more of the information.

The channel is guaranteed to be unique. The member account 1 to n are the accounts of the channel members, and these accounts are issued by the chat server 10. In this embodiment, a bot is registered as a member for notifying information about the reservation of the meeting room 6. The bot may be an agent of the meeting management server 30 or a fictitious member. A bot's speech (text) is sent to the terminal device 60 of the member accounts 1-n.

The workspace and channels are managed by the meeting management server 30 to provide information to identify the group to which the participant belongs.

### «Meetings Management Server»

The meeting management server 30 includes a communication unit 31, a function provided by the reservation management web application 110, and a function provided by the reception support web application 120. Each of these function units of the meeting management server 30 is a function or unit that is implemented in that each of the structure categories illustrated in FIG. 4 is operated by a command from the CPU 501 according to a program deployed from the HD 504 to the RAM 503. The program may be delivered from a program delivery server or distributed as stored on a storage medium.

The reservation management web application 110 and the reception support web application 120 can communicate via an API (Application Interface). Accordingly, the reception support web application 120 can acquire reservation information or the like from the reservation management web application 110 and use it to support the reception. The reservation management web application 110 and the reception support web application 120 may be executed separately by information processing apparatuses.

First, the communication unit 31 sends and receives various information from the reservation management server 20, the chat server 10, the registration terminal 50, the terminal device 60, and the progress management terminal 80. The communication unit 31 includes a sending unit 31a and a receiving unit 31b. The receiving unit 31b receives reservation information from the reservation management server 20 and receives a request for the reservation information from the meeting room terminal 90. The receiving unit 31b receives the check-in request from the meeting room terminal 90. The receiving unit 31b receives the association between the group of the chat system and the account from the registration terminal 50 operated by the managing person. The receiving unit 31b receives information concerning the progress of the task from the progress management terminal 80. The sending unit 31a sends the information concerning the reservation of the meeting room to the chat server 10 and sends the reservation information to the meeting room terminal 90.

The reservation management web application 110 includes an information associating unit 32, a reservation information acquisition unit 33, a notification determination unit 34, a control information generation unit 35, a control information response unit 36, a meeting information notification unit 37, a check-in management unit 38, and a reservation information sending unit 39.

The information associating unit 32 mainly performs processing related to a pre-registration work. That is, the registration of the domain is received from the registration terminal 50 operated by the managing person, registered in the customer domain DB 495, and the workspace and the channel of the chat system sent from the registration terminal 50 and the account of the reservation management server 20 are associated and registered in the associating information DB 491.

The reservation information acquisition unit 33 designates the account of the customer using the progress management system 100, acquires the reservation information from the reservation management server 20, and registers the reservation information as the meeting management information in the meeting management information DB 493. The account of the registration or updated reservation information notified from the reservation management server 20 may be designated or an arbitrary account may be designated. At least a portion of the reservation information of the reservation management server 20 is stored in the meeting management information DB 493. The reservation information acquisition unit 33 acquires the reservation information for a predetermined period from the present from among the reservation information held by the reservation management server 20. The predetermined period depends on how far ahead the reservation of the meeting room 6 is notified.

The notification determination unit 34 determines whether there is a reservation of the start time that satisfies the condition of notification in the meeting management information. For example, referring to the notification setting DB 496, it is determined that the notification will be made when the date and time set is calculated backward from the start time of the reservation. Alternatively, when the reservation information acquisition unit 33 acquires the reservation information from the reservation management server 20, the notification determination unit 34 may generate a task in which the notification determination unit 34 notifies the reservation information and registers the task into the queue. The task saved in the queue is executed when the execution time (the time to remind) arrives. If the bots are separated according to roles, for example, a bot for reminders and a bot for reservation reception, the bots are specified according to the processing.

The meeting information notification unit 37 requests the chat server 10 to specify information identifying the bot (for example, a token in the case of slack) and information specifying the group of the notification destination, and to notify information regarding the reservation of the meeting room 6, when it is determined that the notification determination unit 34 notifies. The notification is made in divided steps, but at least one of the notifications includes the meeting identification information. The meeting identification information is information for the meeting management server 30 to confirm that participants have the right to use the reserved meeting room 6 during a reserved time range. The meeting information notification unit 37 generates the meeting identification information at least before the final notification. The meeting identification information is registered in the meeting identification information DB 494.

When the status of the meeting management information DB becomes check-in, the control information generation unit 35 generates the control information of the electronic device 70 and registers the control information in the control information DB 497. Alternatively, the control information generation unit 35 may, by referring to the meeting management information, generate control information for turning on the power of the electronic device 70 a few minutes before the start time of the meeting. In either case, when the status of the meeting management information DB is checked out, control information for turning off the power of the electronic device 70 is generated.

When the electronic device 70 is present in any meeting room, the control information may be generated for each reservation, but the electronic device 70 is not present in some meeting rooms. In this case, the control information generation unit 35 determines whether the electronic device 70 is included in the prospected participant account of the meeting management information. Because the electronic device 70 is also treated as a resource to be participated in, the existence of an account implying the electronic device 70 can be used to determine whether to generate the control information.

In addition, some meeting rooms are provided with the electronic device 70 capable of communicating with a remote location. In this case, because the reservation person inputs the meeting room in the remote location, the control information generation unit 35 generates control information for connecting with the meeting room in the remote location when the electronic device 70 capable of communicating with the meeting room in the remote location is designated in the reservation information and when the meeting room in the remote location is determined.

The control information response unit receives an inquiry as to whether the control information is present from the meeting room terminal 90 of the meeting room 6 and sends the control information corresponding to the meeting room 6 to the meeting room terminal 90 with reference to the control information DB 497.

The check-in management unit 38 manages the check-in and check-out of the meeting room. Also, the status of the meeting due to the check-in/check-out is registered in the meeting management information DB 493. The check-in is permitted 5 to 10 minutes prior to the start time of the meeting identified by the reservation ID. When the combination of the meeting room ID and the meeting identification information sent by the meeting room terminal 90 is registered in the meeting identification information DB 494, the check-in is permitted.

The reservation information sending unit 39 sends the reservation information (the meeting management information) stored in the meeting management information DB 493 in response to a request from the meeting room terminal 90. The reservation information sending unit 39 may transmit in a JSON format, an XML format, a CVS (Comma-Separated Values) format, or the like. Because the reservation information is sent repeatedly, it is advantageous to use a format with little capacity.

The meeting management server 30 includes a storage unit 49. The storage unit 49 is implemented by the RAM 503, the HD 504, or the like of FIG. 4. The storage unit 49 stores an associating information DB 491, a meeting management information DB 493, a meeting identification information DB 494, a customer domain DB 495, a notification setting DB 496, a control information DB 497, and a meeting room setting information DB 498.

TABLE 3
ASSOCIATING INFORMATION DB

| | | MEMBER | MEMBER | MEMBER | MEMBER |
|---|---|---|---|---|---|
| WORKSPACE | CHANNEL | ACCOUNT 1 | ACCOUNT 2 | ACCOUNT 3 | ACCOUNT 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 shows an example of the associating information stored in the associating information DB 491. The associating information associates the account of the reservation management system and the group of the chat system. The associating information has items of the workspace, channel, and member accounts 1 to n (n=4 in the table). The workspace and channel are as described above. Each account of the participant issued by the reservation management server 20 is registered in the member accounts 1 to n. A chat system account may be registered as illustrated in Table 3. In order to notify the group, it is sufficient to prepare the reservation management server 20 of the user who reserved the meeting and information reservation management server 20 may have information (in this embodiment, the workspace and the channel name) for identifying the account of the user who has reserved the meeting in the reservation management server 20 and the group and channel of the notification destination. It is unnecessary to register the accounts of all members belonging to the group. However, when the notification is done to the individual user, the account information of each chat system is required, so it may be registered as illustrated in Table 3.

TABLE 4
MEETING MANAGEMENT INFORMATION DB

| | RESERVATION | | | | | PROSPECTIVE | |
|---|---|---|---|---|---|---|---|
| RESERVATION | PERSON | MEETING | MEETING | START | END | PARTICIPANT | |
| ID | ACCOUNT | ROOM NAME | ROOM ID | TIME | TIME | ACCOUNT | STATUS |
| 001 | a@xfood.com | COMMERCIAL | K-001 | 2017/07/07 | 2017/07/07 | b@xfood.com | CHECK-IN |
| | | PRODUCT Z | | 10:00 | 12:00 | c@xfood.com | COMPLETED |
| | | DEVELOPMENT | | | | d@xfood.com | |
| | | MEETING | | | | | |
| 002 | e@xfood.com | COMMERCIAL | K-001 | 2017/07/07 | 2017/07/07 | f@xfood.com | ALREADY |
| | | PRODUCT Y | | 13:00 | 14:00 | g@xfood.com | NOTIFIED |
| | | DEVELOPMENT | | | | | |
| | | MEETING | | | | | |
| . . . | . . . | . . . | . . . | . . . | . . . | . . . | . . . |

Table 4 shows an example of the meeting management information stored in the meeting management information DB 493 of the meeting management server 30. Because the reservation information is stored in the meeting management information DB 493, the difference from the reservation information DB 291 in Table 1 is explained with reference to Table 4. The meeting management information in Table 4 includes the notation name of the reservation person, the department name of the reservation person, the notation name of the participant, the department name of the participant, and the status. The notation name of the reservation person is in the sir name and given name of the reservation person. The department name of the reservation person is the department name to which the reservation person belongs. The notation name of the participant is the sir name and given name of the participant. The department name of the participant is the name of the department to which the participant belongs. Because the meeting management server 30 retains or can use the user information associated with the account, the notation name, the department name, or the like. Therefore, when the account is known, the user information is also known. Further, the reservation management server 20 may include the notation name of the reservation person, the department name of the reservation person, the notation name of the participant, and the department name of the participant at the time of sending from the reservation management server 20.

The status means the state of the reservation. For example, the states of whether the information related to the reservation of the meeting room 6 is already notified, confirmation of use, whether check-in is completed, check-out, or cancellation about the reservation in the meeting room 6 are registered.

TABLE 5
MEETING IDENTIFICATION INFORMATION DB

| | | MEETING |
|---|---|---|
| RESERVATION | MEETING | IDENTIFICATION |
| ID | ROOM ID | INFORMATION |
| 001 | K-001 | 1234 |
| 002 | K-002 | 5678 |
| . . . | . . . | . . . |

Table 5 shows an example of the meeting identification information management information of the meeting identification information DB 494. The meeting identification information management information is information that manages the Meeting Identification Information for each reservation in the meeting room 6. The meeting identification information management information includes the reserved ID, the meeting room ID, and each item of the meeting identification information. These are the same as the reservation information except for the status (the reservation information received from the reservation management server 20) and the already explained explanatory reservation information may be omitted from the explanation thereof. Note that the reservation ID is registered in order to identify the reservation in the same meeting room 6.

TABLE 6
CUSTOMER DOMAIN DB

| CUSTOMER | CUSTOMER |
|---|---|
| DOMAIN NAME | MANAGER ACCOUNT |
| xfood.com | a@xfood.com |
| ycar.com | f@ycar.com |
| . . . | . . . |

Table 6 shows an example of the customer domain information stored in the customer domain DB 495. The customer domain information is information that manages the customer domain and the account of the customer managing person. In the customer domain information, the customer domain name and a customer managing person account are associated and registered. The customer domain of Table 6 is the account (e-mail address) domain issued by the reservation management server 20. The managing person account is the account of the customer's managing person (representing). The account in Table 6 is issued by the reservation management server 20.

TABLE 7
NOTIFICATION SETTING DB

| CUSTOMER DOMAIN NAME | NOTIFICATION SETTING |
|---|---|
| xfood.com | BEFORE 1 DAY |
| ycar.com | BEFORE 12 HOURS |
| . . . | . . . |

Table 7 shows an example of notification setting information stored in notification setting DB 496. Notification setting information retains notification setting for each customer. The customer domain name and notification setting are registered in the notification setting information. The notification setup is timed to inform about the reservation of meeting room 6, just before the start time of the meeting. Alternatively, a predetermined date and time may be set. Also, it is not necessary to have one timing, and multiple notification settings may be registered for one customer.

TABLE 8
CONTROL INFORMATION DB

| MEETING ROOM ID | CONTROL CONTENT |
|---|---|
| K-001 | POWER ON |
| K-002 | POWER OFF |
| . . . | . . . |

Table 8 shows an example of control information stored in control information DB 497. The control information is information for controlling the electronic device 70 of the meeting room 6. The control information includes the meeting room ID and each item of the control contents. The control is a specific control method of the electronic device 70. The meeting management server 30 can set detailed control contents for each electronic device 70. Further, the time to be controlled is not registered because it is difficult to transmit the time from the meeting management server 30 of the external network to the meeting room terminal 90, and the meeting room terminal 90 accesses the meeting management server 30, and at this time, if the control information is generated, the control contents are sent.

TABLE 9
MEETING ROOM SETTING INFORMATION DB

| | | | STATE OF | | | |
|---|---|---|---|---|---|---|
| CUSTOMER | MEETING | MEETING | MEETING ROOM | AUTHENTICATION | MANAGEMENT | OPERATION |
| ID | ROOM NAME | ROOM ID | TERMINAL | KEY | START FLAG | RULE |
| G-001 | MEETING | K-001 | DURING | ***** | True | A |
| | ROOM A | | CONNECTION | | | |
| | MEETING | K-002 | BEFORE | ***** | False | A |
| | ROOM B | | SETUP | | | |
| | MEETING | K-003 | DISCONNECTED | ***** | True | B |
| | ROOM C | | | | | |
| | MEETING | K-004 | DURING | ***** | True | C |
| | ROOM D | | CONNECTION | | | |
| | MEETING | K-005 | DURING | ***** | True | A |
| | ROOM E | | CONNECTION | | | |

Table 9 shows an example of the meeting room setting information stored in the meeting room setting information DB 498. Meetings room setting information is information about the setting for each meeting room. The meeting room setting information corresponds to the customer ID and includes the meeting room name, the meeting room ID, the state of the meeting room terminal 90, the authentication key, the management start flag, and each item of the operation rules.
The name of the meeting room is the general name of the meeting room that the participants are aware of and is presented, for example, at the entrance to the meeting room.
The Meeting Room ID is the identification information that uniquely identifies the meeting room as described above. Briefly, the meeting room ID may be common to the reservation management server 20. A conversion table may be provided to be set by a managing person separately from the reservation management server 20.
The state of the meeting room terminal 90 indicates whether the initial setting of the meeting room terminal 90 has been completed, whether communication is possible, or the like. Thus, “disconnected” means it impossible to communicate with the meeting room terminal 90.
Connected: Confirmed communication within a certain period of time.
Before setup: Before initialization
Disconnection: No communication for more than a certain period
   The authentication key is the authentication information for authenticating the meeting room terminal 90 by the meeting management server 30.

By an initial setting, the authentication key is sent to the meeting room terminal 90 and the meeting room terminal 90 stores the authentication key. At the time of communication, the meeting room terminal 90 is authenticated by the authentication key. Authentication keys are combinations of a numbers, alphabets, symbols, etc., that are too long to be identified by the brute-force method. The authentication key may be determined by the meeting management server 30 or by the managing person.
The management start flag is a flag (True: starting False: not starting) indicating whether the management of the meeting room is started by the meeting management server 30 after the initial setting of the meeting room terminal 90 is completed. Because there is a management start flag, it is possible to suppress the inconvenience caused by the time lag from the completion of the initial setting to the arrangement of the meeting room terminal 90.
Operation rules indicate which of several rules to use for operating the meeting room. The operation rules include, for example, whether an automatic cancellation is to be performed, whether an automatic cancellation is to be performed without a check-in, or whether the electronic device 70 is to be activated at the start time of the meeting.

Next, the reception support web application 120 will be described. The reception support web application 120 includes an information synchronization unit 121, a workflow reception screen generation unit 122, a mail sending unit 123, a progress management unit 124, a progress management screen generation unit 125, and a screen information sending unit 126.

The information synchronization unit 121 synchronizes the information necessary for the reception support web application 120 to the reservation management web. In this embodiment, the reservation information including the status and the operation rules are synchronized. For example, it periodically inquires and acquires new reservation information, if any, along with the operation rules that apply to this reservation information.

The workflow reception screen generation unit 122 generates screen information of the screen for setting the reception workflow and the visitor registration form by the managing person and sends the screen information to the registration terminal 50 through the communication unit 31. The workflow reception screen generation unit 122 also generates screen information necessary for setting the progress management screen. Screen information is prepared by HTML, XML, CSS (Cascade Style Sheet) and JavaScript (“JavaScript” is a registered trademark).

The mail sending unit 123 sends an e-mail to the reservation person included in the reservation information to prompt the reservation person to register the visitor information using the visitor registration form. The timing for sending may be a predetermined time after the reservation information is registered. If the reservation person does not respond to the e-mail (unless the visitor information is set by depressing the URL described below, for example, the reservation person repeatedly sends the e-mail at a fixed time once a day. When the reserved date and time are approaching, the frequency may be high, such as once every few hours.

The progress management unit 124 updates the information stored in the progress management information DB 132 based on the information on the progress of the task received from each progress management terminal 80.

The progress management screen generation unit 125 generates screen information of the progress management screen based on the information stored in the workflow setting information DB 131 and the progress management information DB 132. When the information stored in the progress management information DB 132 is updated, the progress management screen generation unit 125 newly generates the screen information of the progress management screen.

The screen information sending unit 126 sends the screen information of the progress management screen generated by the progress management screen generation unit 125 to the progress management terminal 80. There is a method for sending using polling performed by the browser software of the progress management terminal 80. In this case, JavaScript (“JavaScript” is a registered trademark), which is a part of the screen information of the progress management screen, is described as performing polling.

Alternatively, the WebSocket protocol may be utilized. In the WebSocket protocol, the server and the client perform a connection once and then perform all the necessary communications on the connection using a dedicated protocol. Unlike polling, it prevents new connections and reduces the load on the server side. Because the connection is always set, the screen information sending unit 126 can transmit the screen information of the progress management screen to all the progress management terminals 80 displaying the progress management screen. When the screen information is sent, the progress management terminal 80 that has sent the information on the progress of the task may be excluded. In this case, JavaScript (“JavaScript” is a registered trademark) changes the progress management screen of the progress management terminal 80 that has sent the information on the progress of the service. It may be implemented by holding the identification information (such as IP address) of the progress management terminal 80 in which the progress management unit 124 sends the information concerning the progress of the task.

The meeting management server 30 includes a storage unit 129 used by the reception support web application 120. The storage unit 129 is implemented by the RAM 503, the HD 504, or the like of FIG. 4. The workflow setting information DB 131 and the progress management information DB 132 are stored in the storage unit 129.

TABLE 10
WORKFLOW SETTING INFORMATION DB

| OPERA- | VISITOR | | | | | |
|---|---|---|---|---|---|---|
| TION | | | NUMBER OF | | NUMBER OF | |
| RULE | DRINK | | VISITORS | | EMPLOYEES | |
| A | MANDATORY | DISPLAY | MANDATORY | DISPLAY | MANDATORY | DISPLAY |

| OPERA- | | | | | | | | | | |
|---|---|---|---|---|---|---|---|---|---|---|
| TION | | | | | | | | | | |
| RULE | RECEPTION WORKFLOW | | | | | | | | | |
| A | CARD | CALL UP | GUIDING | ROOM | SERVING | EXITING | CLEANING | OUT | SEEING | RETURNING |
| | PRESEN- | EMPLOYEE | IN | ENTRY | DRINK | ROOM | UP | OF | OFF | CARD |
| | TATION | | LOBBY | (CHECK- | | (CHECK- | | LOBBY | | |
| | | | | IN) | | OUT) | | | | |

Table 10 shows an example of the workflow setting information stored in the workflow setting information DB 131. The workflow setting information is the information set by the managing person for the visitor registration form and the reception workflow. The workflow setting information includes items of the visitor registration form and reception workflow in association with the operation rules. The visitor registration form includes items for the reservation person to register information about visitors in the meeting room. These items are, for example, the drink, the number of visitors, and the number of employees, each of which is associated with items of mandatory and display. This means that in meeting room where an operation rule A applies, the drink, the number of visitors, the number of employees are displayed on the progress management screen. Mandatory means that the reservation person must set the item, and display means that the item is displayed on the progress management screen in the initial state (immediately after opening the screen). The visitor registration form may also contain other items of information about the visitor, such as a telephone number, mail address, visitor's car number, parking lot number, etc. Items of information related to employee may be present.

The reception workflow includes the following items: card presentation, calling up employee, guiding in lobby, room entry, serving drink, exiting room, cleaning up, in lobby seeing off, and returning card. These items correspond to the phase of the reception workflow, and each item is collectively referred to as the reception workflow. This reception workflow is only an example and may have more phases or fewer phases.

The reception workflow may be associated with the meeting room, not to the operation rule. It may also be set for each reservation information.

TABLE 11

| | PROGRESS MANAGEMENT INFORMATION DB | | | | | |
|---|---|---|---|---|---|---|
| | RESERVATION | MEETING | | | | |
| RESERVATION | PERSON | ROOM | START | END | | |
| ID | ACCOUNT | NAME | TIME | TIME | STATUS | DEPARTMENT |
| 001 | a@xfood.com | K-001 | 2017/07/07 | 2017/07/07 | CHECK-IN | DEPARTMENT |
| | | | 10:00 | 12:00 | COMPLETED | 1 |
| 002 | e@xfood.com | K-001 | 2017/07/07 | 2017/07/07 | ALREADY | DEPARTMENT |
| | | | 13:00 | 14:00 | NOTIFIED | 2 |

| | | VISITOR INFORMATION | | | RECEPTION WORKFLOW |
|---|---|---|---|---|---|
| RESERVATION | TELEPHONE | | NUMBER OF | NUMBER OF | CARD |
| ID | NUMBER | DRINK | VISITORS | EMPLOYEES | PRESENTATION |
| 001 | XXXX-XXXX | COFFEE | 1 | 1 | DONE |
| 002 | YYYY-YYYY | GREEN | 2 | 3 | NOT |
| | | TEA | | | YET |

| | RECEPTION WORKFLOW | | | | | | |
|---|---|---|---|---|---|---|---|
| | | | ROOM | | EXITING | | |
| | | GUIDING | ENTRY | | ROOM | | |
| RESERVATION | CALL UP | IN | (CHECK- | SERVING | (CHECK- | CLEANING | OUT OF |
| ID | EMPLOYEE | LOBBY | IN) | DRINK | OUT) | UP | LOBBY |
| 001 | DONE | DONE | DONE | DONE | NOT | NOT | NOT |
| | | | | | YET | YET | YET |
| 002 | NOT | NOT | NOT | NOT | NOT | NOT | NOT |
| | YET | YET | YET | YET | YET | YET | YET |

| | RECEPTION WORKFLOW | | | | |
|---|---|---|---|---|---|
| RESERVATION | SEEING | RETURNING | VISITOR | | |
| ID | OFF | CARD | ATTRIBUTE INFORMATION | | |
| 001 | NOT | NOT | NAME | COMPANY | MAIL |
| | YET | YET | | NAME | ADDRESS |
| 002 | NOT | NOT | SATOH | SAMPLE | sato@sample.com |
| | YET | YET | | COMPANY | |

Table 11 shows an example of the progress management information stored in the progress management information DB 132. The progress management information includes items of reservation information (reservation ID, reservation person account, meeting room name, start time, end time, status), visitor information, reception workflow, and visitor attribute information. When the information synchronization unit 121 acquires the reservation information from the reservation management web application 110, the progress managing unit 124 creates one record of the progress management information. Based on the meeting room ID included in the reservation information, acquires the ID of the operation rule of the meeting room setting information DB 498, and acquires the visitor registration form and the reception workflow associated with the ID of this operation rule from the workflow setting information DB 131. At the time a single record of progress management information is created, the value of visitor information may be blank, and the values of the reception workflow are “not yet”. In addition, items of the department and telephone number and the item of the visitor attribute information are added to the reservation information. This is to use the information related to the visitor for the progress management.

The reservation person accesses the URL described in the e-mail as described below and sets up the department, telephone number, visitor information (drink, number of visitors, and number of employees), and visitor attribute information (name, company name, and e-mail address).

As for the reception workflow, the progress managing person 3 confirms the phase and registers it with the meeting management server 30, so the phase is gradually updated. The updating changes “Not yet” to “Done”. Regarding “room entry” and “exiting room” may be changed by synchronizing with the status of the meeting management information DB 493.

In addition to the visitor information, the department, telephone number, and visitor attribute information (the name, company name, and e-mail address) are set to be mandatory or not. If the reservation person does not access the URL described in the e-mail and enter the items of mandatory, the e-mail is sent again.

### «Registration Terminal»

The registration terminal 50 includes a communication unit 51, an operation reception unit 52, and a display control unit 53. Each of these function units provided by the registration terminal 50 is a function or unit implemented by one of the components illustrated in FIG. 4 operating according to a command from the CPU 501 according to a program deployed from the HD 504 to the RAM 503. The program is, for example, browser software.

The registration terminal 50 is a terminal for performing various settings related to the meeting room by the managing person through the web page provided by the meeting management server 30. In this embodiment, the registration terminal 50 is used to display the workflow reception screen 600.

The communication unit 51 of the registration terminal 50 sends and receives various information with the meeting management server 30. For example, the communication unit 51 receives meeting room setting information for each meeting room or sends information set by the managing person regarding the meeting room setting information.

The operation reception unit 52 receives various operations for the registration terminal. The display control unit 53 analyzes various screen information from the meeting management server 30 and displays it on the display 506.

### «Progress Management Terminal»

The progress management terminal 80 includes a communication unit 81, an operation reception unit 82, and a display control unit 83. Each of these function units provided by the progress management terminal 80 is a function or unit implemented in which any one of the components illustrated in FIG. 4 is operated by a command from the CPU 501 according to a program expanded from the HD 504 to the RAM 503. This program assumes browser software.

The progress management terminal 80 is used by the progress managing person 3 to manage whether each phase of the reception is properly executed based on the reception workflow.

The communication unit 81 of the progress management terminal 80 sends and receives various information with the meeting management server 30. For example, if the reception workflow is updated by polling, the screen information of the progress management screen including the updated reception workflow is received. Alternatively, a WebSocket protocol may be used to receive communications from the meeting management server 30. The information in the progress management information DB 132 can be updated in real time, not only in the reception workflow.

The operation reception unit 82 receives various operations from the progress management terminal 80. The display control unit 83 analyzes various screen information (for example, a progress management screen) from the meeting management server 30 and displays it on the display 506.

### «Terminal Device»

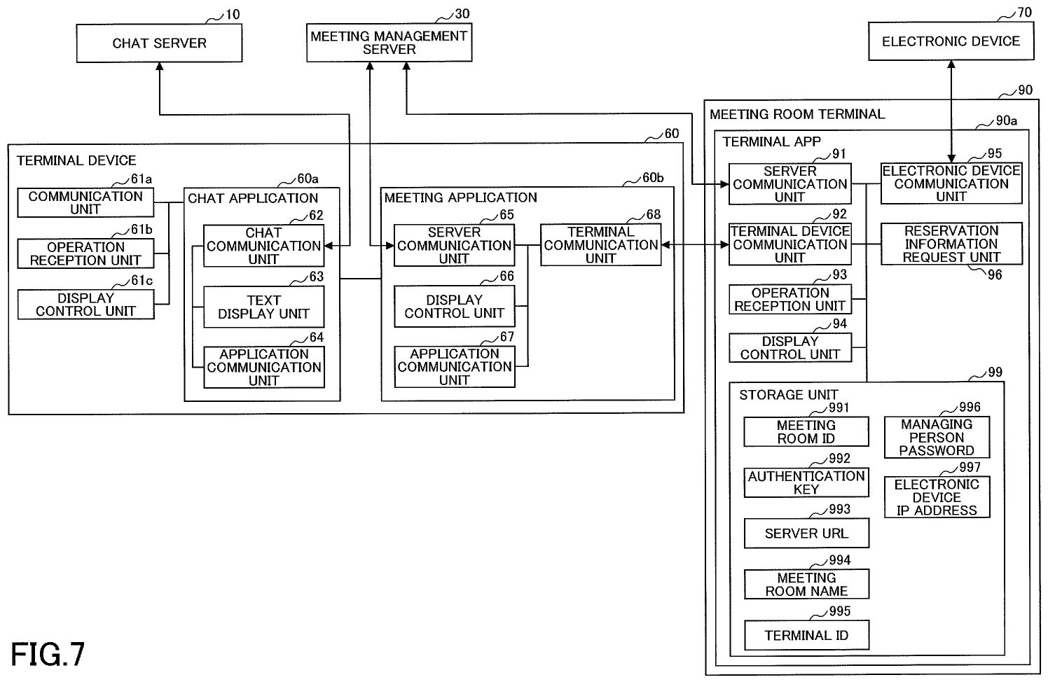

FIG. 7 is a functional block diagram illustrating an example of the function of the terminal device 60 and the meeting room terminal 90 in a block shape. The function of the electronic device 70 will be described as needed.

The terminal device 60 includes a communication unit 61a, an operation reception unit 61b, a display control unit 61c, a chat communication unit 62, a text display unit 63, an application communication unit 64, a server communication unit 65, a display control unit 66, an application communication unit 67, and a terminal communication unit 68. Each of the function units provided by the terminal device 60 is a function or a unit that is implemented in which each of the structures illustrated in FIG. 4 is operated by a command from the CPU 501 according to a program deployed from the HD 504 to the RAM 503. The program may be delivered from a program delivery server or distributed as stored on a recording medium. Because the chat application 60a and the meeting application 60b are operated in the terminal device 60, the program includes the chat application 60a and the meeting application 60b.

The communication unit 61a sends and receives various information from the meeting management server 30 and the reservation management server 20. The chat application 60a communicates with the chat server 10 and the meeting application 60b communicates with the meeting management server 30, whereas the communication unit 61 communicates with any server. The communication unit 61a may be provided, for example, as a browser function.

The operation reception unit 61b receives various operations of the participant in the terminal device 60. The display control unit 61c interprets screen information of various screens and displays the screen information on the LCD 206. The operation reception unit 61b and the display control unit 61c have, for example, a browser function and can execute a web application. For example, the display control unit 61c displays the reservation setting screen received from the reservation management server 20, and the operation reception unit 61b receives reservation information set by the reservation person.

The chat communication unit 62 of the chat application 60a sends and receives various information from the chat server 10. According to the present embodiment, the information regarding the reservation of the meeting room 6 is received from the chat server 10, and the chat server 10 is notified of the fact that the meeting room 6 has already been read, whether the meeting room 6 is used or cancelled, or the like.

The text display unit 63 of the chat application 60a displays the text (information concerning the reservation of the meeting room 6) sent from the chat server 10. For example, the utterance is a bot and the text is displayed as if the bot had input it.

The application communication unit 64 of the chat application 60a calls the meeting application 60b and sends the meeting identification information to the meeting application 60b. The chat server 10 sends information identifying the meeting application 60b to the terminal device 60 when the information regarding the reservation of the meeting room 6 is notified. Therefore, the chat application 60a designates the meeting application 60b to the OS and requests the OS to notify the meeting identification information. The OS can start the meeting application 60b.

The server communication unit 65 of the meeting application 60b communicates with the meeting management server 30. A two-dimensional code including the meeting identification information is acquired from the meeting management server 30 or the like. The two-dimensional code is used for authentication when checked in. It may be a number of digits for authentication.

The display control unit 66 of the meeting application 60b displays the two-dimensional code including the meeting identification information on the LCD 206. The application communication unit 67 of the meeting application 60b acquires various information (such as meeting identification information included in the information concerning the reservation of the meeting room 6) from the chat application 60a through the OS.

The terminal communication unit 68 communicates with the meeting room terminal 90 and sends the meeting identification information. The terminal communication unit 68 detects the presence of the meeting room terminal 90 by near range radio communication such as Bluetooth (“Bluetooth” is a registered trademark) and sends the meeting identification information when the meeting room terminal 90 is detected. Further, a function for displaying (capturing) a two-dimensional code is provided to the meeting room terminal 90.

### «Meeting Room Terminal»

The meeting room terminal 90 includes a server communication unit 91, a terminal device communication unit 92, an operation reception unit 93, a display control unit 94, an electronic device communication unit 95, and a reservation information request unit 96. Each of these function units provided by the meeting room terminal 90 is a function or unit implemented in which each of the structures illustrated in FIG. 5 is operated by a command from the CPU 401 according to a program deployed from the EEPROM 404 to the RAM 403. The program includes a terminal application 90a which is delivered from a program delivery server or distributed as stored on the recording medium. When the terminal application 90a is installed in the meeting room terminal 90, these functions are implemented.

The server communication unit 91 communicates with the meeting management server 30 by using the server URL 993 as the destination. Because the meeting room terminal 90 is present in the internal network, it is difficult to communicate with the meeting room terminal 90 from the meeting management server 30. For this reason, the server communication unit 91 communicates with the meeting management server 30 by a communication technology such as polling (regularly communicating with the meeting management server 30) or the WebSocket protocol. The server communication unit 91 may communicate with a communication protocol such as HTTP, and the communication protocol is not particularly limited.

The server communication unit 91 according to the present embodiment receives the reservation information and sends the meeting identification information received by the terminal device communication unit 92 from the terminal device 60 or the manually input meeting identification information to the meeting management server 30 at the check-in time. The server communication unit 91 receives the control information from the meeting management server 30.

The terminal device communication unit 92 communicates with the terminal device 60. In this embodiment, the meeting identification information or the like is received. When the meeting identification information is input by hand, the terminal device communication unit 92 may not be necessary. The terminal device communication unit 92 is implemented by a program executed by the CPU 401 of FIG. 5 and controlling the short range communication circuit 420.

The electronic device communication unit 95 communicates with the electronic device 70. In the present embodiment, the control information received by the server communication unit 91 is sent to the electronic device 70. The electronic device communication unit 95 is implemented by a program executed by the CPU 401 of FIG. 5 to control the telecommunication circuit 412.

At a periodic timing of acquiring the reservation information, the reservation information request unit 96 repeatedly sends the meeting room ID 991 and the authentication key 992 to the meeting management server 30 to the destination of the server URL 993 stored in the storage unit 99 through the server communication unit 91. As a response, the reservation information request unit 96 acquires the reservation information through the server communication unit 91. The reservation information can be acquired only when there is a change. The timing occurs at a cycle of every several second to several minute. The shorter the cycle, the earlier the reservation information can be updated, but the higher the communication load, the decision is made by weighing both. In this embodiment, for example, 30 seconds. At least the meeting management information (reservation information) of the meeting room 6 of the present day can be received through the server communication unit 91.

The meeting room terminal 90 includes a storage unit 99. The storage unit 99 is implemented by the ROM 402, the EEPROM 404, or the like of FIG. 5. The storage unit 99 stores a meeting room ID 991, authentication key 992, server URL 993, meeting room name 994, terminal ID 995, managing person password 996, and IP address 997 of the electronic device 70. These are stored in the storage unit 99 by the initial setting of the meeting room terminal 90.

### <Example of Screen Structure>

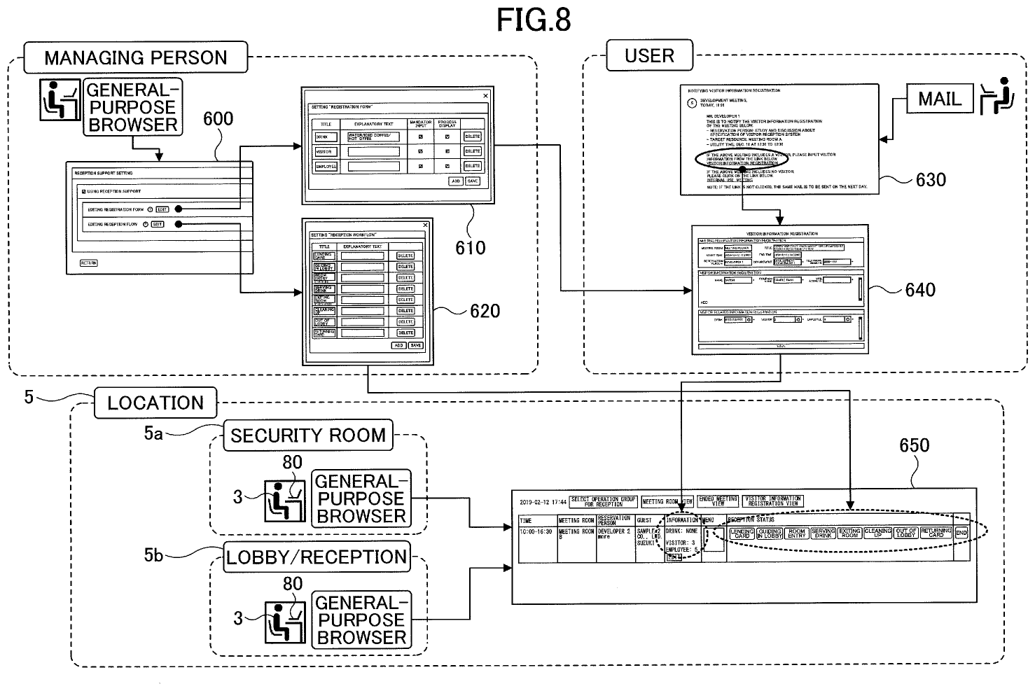

Next, an example of a screen structure described in this embodiment will be described with reference to FIG. 8. FIG. 8 is a diagram illustrating the relationship of screens operated by the managing person, reservation person, or progress managing person 3. The details of each screen illustrated in FIG. 8 will be described later.

First, the managing person displays a workflow reception screen 600 by operating the registration terminal 50. The workflow reception screen 600 transitions to a phase registration screen 620 and visitor registration form screen 610 by the managing person. The information set in the phase registration screen 620 and the visitor registration form screen 610 is stored in the workflow setting information DB 131.

The reservation person operates the terminal device 60 to display the e-mail 630. The e-mail 630 contains a URL or a text linked to the URL, and when the reservation person clicks on the URL, the display screen of the e-mail 630 transitions to the visitor information registration screen 640. The visitor information registration screen 640 reflects the contents set in the visitor registration form screen 610.

The progress managing person 3 operates the progress management terminal 80 to display the progress management screen 650. The progress management screen 650 reflects the information input by the reservation person on the visitor information registration screen 640 and the information input on the phase registration screen 620. Further, the progress input by each progress managing person 3 by the progress management screen 650 is reflected in the progress management screen 650 of progress management terminals 80.

### <Workflow Setting Procedure>

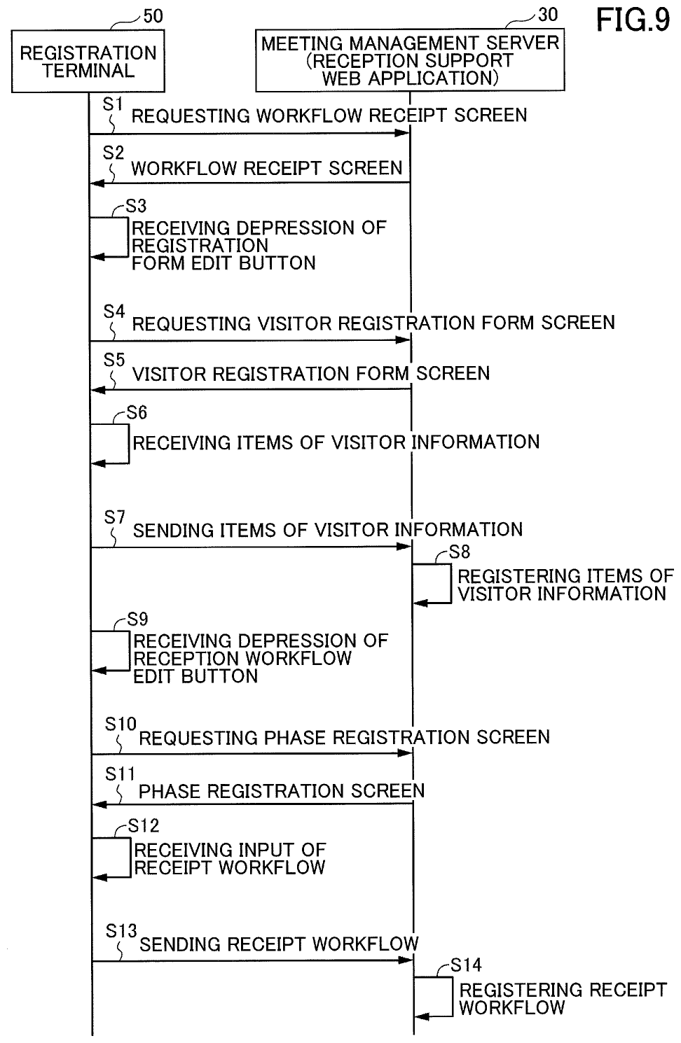

Next, a procedure for setting the reception workflow will be described with reference to FIG. 9. FIG. 9 is an example of a sequence diagram illustrating a procedure in which a managing person sets a reception workflow. The explanation in FIG. 9 describes the operations of the managing person of

FIG. 8.

S1: The managing person first operates the registration terminal 50 to communicate with the meeting management server 30, and requests the meeting management server 30 to send the workflow reception screen 600. The receiving unit 31b of the meeting management server 30 receives the request. In addition, the managing person shall have selected the operation rule in advance.

S2: Accordingly, the workflow receipt screen generation unit 122 generates screen information of the workflow reception screen 600, and the sending unit 31a sends screen information of the workflow reception screen 600 to the registration terminal 50.

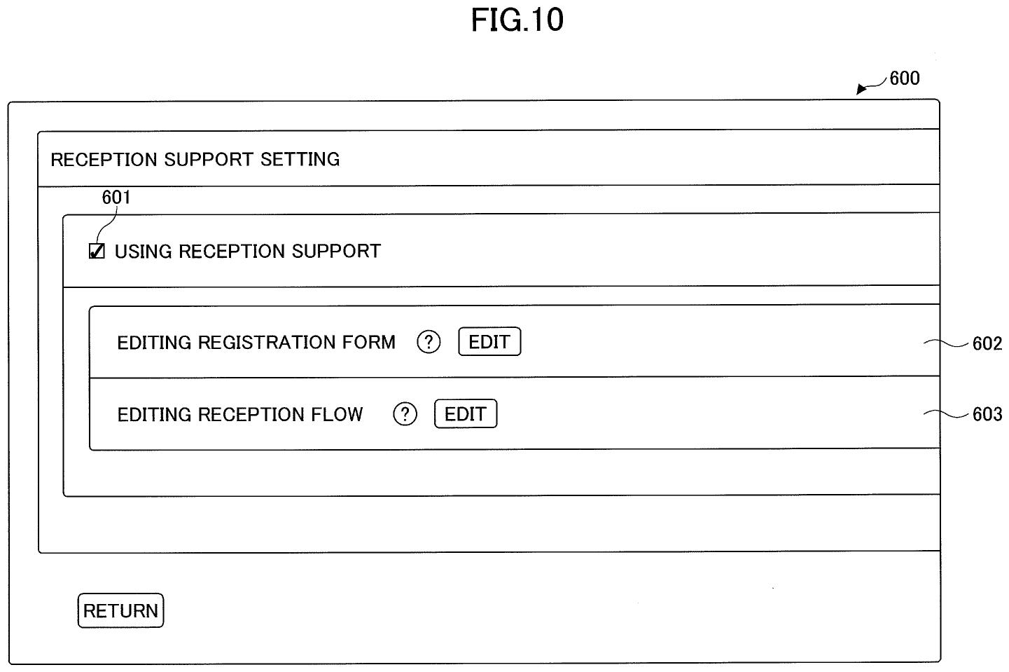

S3: The communication unit 51 of the registration terminal 50 receives the screen information of the workflow reception screen 600, and the display control unit 83 displays the workflow reception screen 600 on the display 506 of the registration terminal 50 (see FIG. 10). First, the managing person depresses a registration form edit button 602, but may press a reception workflow edit button 603 first. The operation reception unit 82 receives depressing of the registration form edit button 602.

S4: The communication unit 51 of the registration terminal 50 requests the meeting management server 30 to send a visitor registration form screen 610. The receiving unit 31b of the meeting management server 30 receives the request.

S5: Accordingly, the workflow reception screen generation unit 122 generates screen information of the visitor registration form screen 610, and the sending unit 31a sends the screen information of the visitor registration form screen 610 to the registration terminal 50.

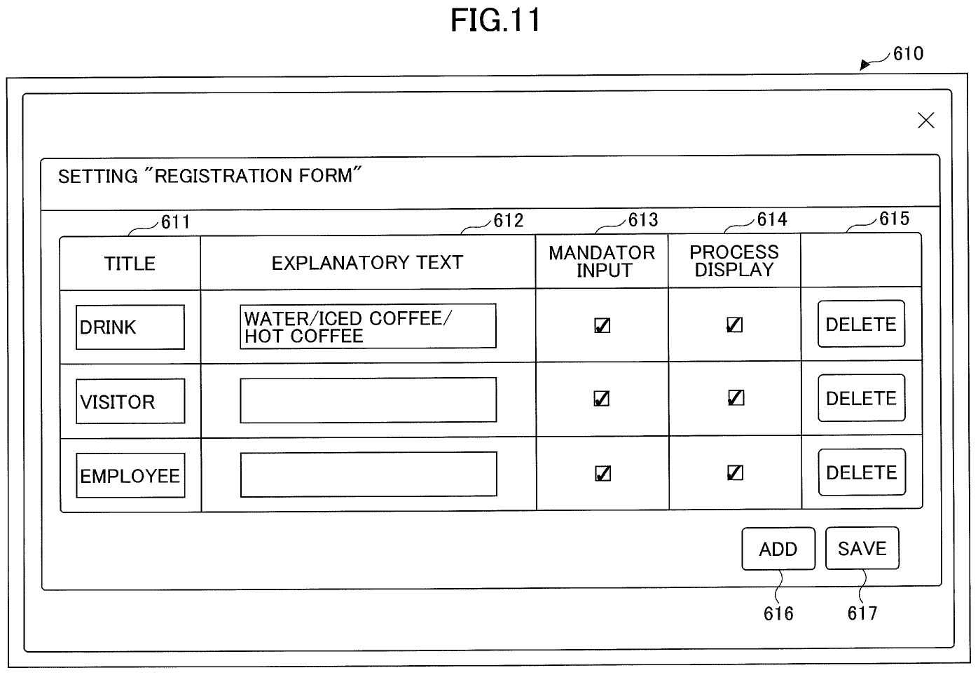

S6: The communication unit 51 of the registration terminal receives the screen information of the visitor registration form screen 610, and the display control unit 83 displays the visitor registration form screen 610 on the display 506 of the registration terminal 50 (see FIG. 11). The managing person inputs the item of visitor information on the visitor registration form screen 610. The operation reception unit 82 receives an input of an item of visitor information.

S7: The communication unit 51 of the registration terminal 50 sends the item of the visitor information to the meeting management server 30 together with the operation rule.

S8: The receiving unit 31b of the meeting management server 30 receives the item and operation rule of the visitor information, and the workflow reception screen generation unit 122 associates the item of the visitor information with the operation rule and registers the item of the visitor information in the workflow setting information DB 131.

S9: The managing person then transitions the screen back to, for example, the workflow reception screen 600. The managing person depresses the reception workflow edit button 603. The operation reception unit 82 receives the depressing of the reception workflow edit button 603. Incidentally, the transition of the screen is only one example, and it is sufficient that the registration terminal 50 can display the phase registration screen 620.

S10: The communication unit 51 of the registration terminal requests the meeting management server 30 to send the phase registration screen 620. The receiving unit 31b of the meeting management server 30 receives the request.

S11: Accordingly, the workflow reception screen generation unit 122 generates the screen information of the phase registration screen 620, and the sending unit 31a sends the screen information of the phase registration screen 620 to the registration terminal 50.

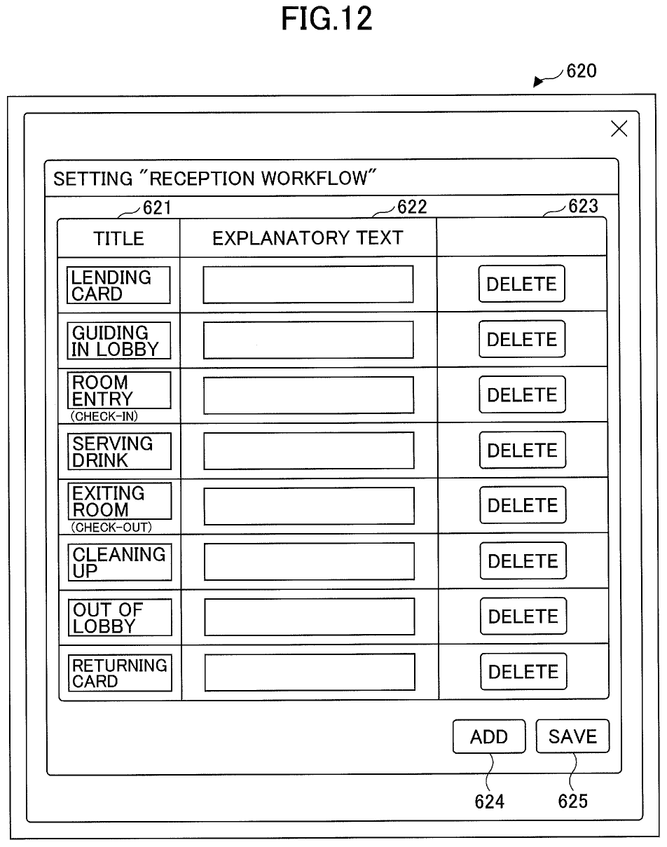

S12: The communication unit 51 of the registration terminal receives screen information of the phase registration screen 620, and the display control unit 83 displays the phase registration screen 620 on the display 506 of the registration terminal 50 (see FIG. 12). The managing person enters the reception workflow with one or more phases into the phase registration screen 620. In many cases, the phases are multiple and often input in chronological order. The operation reception unit 82 receives the input of the reception workflow.

S13: The communication unit 51 of the registration terminal 50 sends the reception workflow to the meeting management server 30 together with the operation rule.

S14: The receiving unit 31b of the meeting management server 30 receives the reception workflow and the operation rule, and the workflow reception screen generation unit 122 associates the reception workflow with the operation rule and registers the reception workflow in the workflow setting information DB 131.

### <Example of Workflow Reception Screen, Visitor Registration Form Screen, and Phase Registration Screen>

FIG. 10 illustrates an example of the workflow reception screen 600. FIG. 11 illustrates an example of the visitor registration form screen 610. FIG. 12 illustrates an example of the phase registration screen 620.

As illustrated in FIG. 10, the workflow reception screen 600 includes a check box 601, a registration form edit button 602, and an reception workflow edit button 603 that are associated with the message “using reception support setting”. When the check box 601 is checked, the registration form edit button 602 and reception workflow edit button 603 become valid.

The registration form editing button 602 is a button for displaying the visitor registration form screen 610 and the reception workflow edit button 603 is a button for displaying the phase registration screen 620.

As illustrated in FIG. 11, the visitor registration form screen 610 allows the managing person to set values line by line using a title 611, explanatory text 612, mandatory input 613, process display 614, and delete button 615 as one line. FIG. 11 illustrates three lines. The title 611 is the item name of the visitor information and may be input by an arbitrary value. The explanatory text 612 is an item that is previously described by the managing person as a value that can be input by the reservation person. The mandatory input 613 is checked for the item that needs to be input by the reservation person. The process display 614 designates a title 611, which is displayed by the progress management terminal 80 at its initial state. The delete button 615 is a button for deleting one line.

When the managing person depresses an add button 616, a new line (title, explanatory text, mandatory input, process display, and delete buttons) is additionally displayed. When a save button 617 is depressed the items of the visitor information registered in the visitor registration form screen 610 are sent to the meeting management server 30. The item of the visitor information registered in the visitor registration form screen 610 is stored in the workflow setting information DB 131 illustrated in table 10.

As illustrated in FIG. 12, the phase registration screen 620 allows a managing person to set a value for each row using the title 621, the explanatory text 622, and the delete button 623 as one line. The title 621 is a phase name and can input an arbitrary value, and the explanatory text 622 is an item to be described by the managing person. A delete button 623 is a button for deleting one line.

The title of “room entry” is marked “check-in” and the title of “exit room” is described “check-out”. This means that the managing person causes the title to associate with check-in or check-out. For example, check-in or check-out can be selected by continuously depressing the title for a long time. The progress management information DB 132 is set to be a phase corresponding to check-in or check-out.

When the managing person depresses the add button 624, a new line (a title, explanatory text, and delete button) is additionally displayed. When the save button 625 is depressed, the reception workflow inputted in the phase registration screen 620 is sent to the meeting management server 30. The reception workflow registered in the phase registration screen 620 is stored in the workflow setting information DB 131 shown in Table 10.

The title 621 may be selected by the managing person from a pull-down menu rather than being freely entered by the managing person.

### <Registration Procedure of Visitor Information>

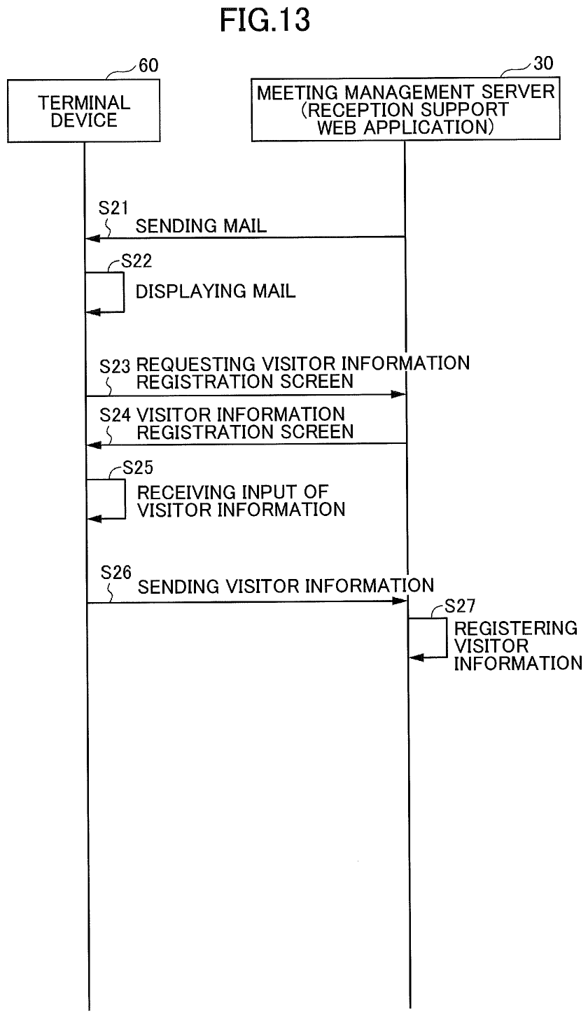

Next, a procedure for setting visitor information will be described with reference to FIG. 13. FIG. 13 is an example of a sequence diagram illustrating a procedure in which a reservation person registers visitor information. The operation of the reservation person of FIG. 8 is described in the explanation of FIG. 13. When the information synchronization unit 121 acquires the reservation information from the reservation management web application, the progress management unit 124 generates one record for each reservation information in the progress management information DB.

S21: First, the mail sending unit 123 of the meeting management server 30 sends mail to the reservation person. The mail sending unit 123 generates and sends an e-mail 630 to prompt the registration of the visitor information using the reservation person account included in the reservation information acquired by the information synchronization unit 121 as a destination. The mail sending unit 123 identifies the progress management information in which a value is not set to the items of mandatory such as the visitor information from the progress management information DB 132 and sends the information at a predetermined timing. The progress management information may be sent irregularly. The text of email 630 is generated from the progress management information. The mail sending unit 123 generates the URL of the visitor information registration screen 640 as described below and causes the URL to be described in the e-mail or linked to a character.

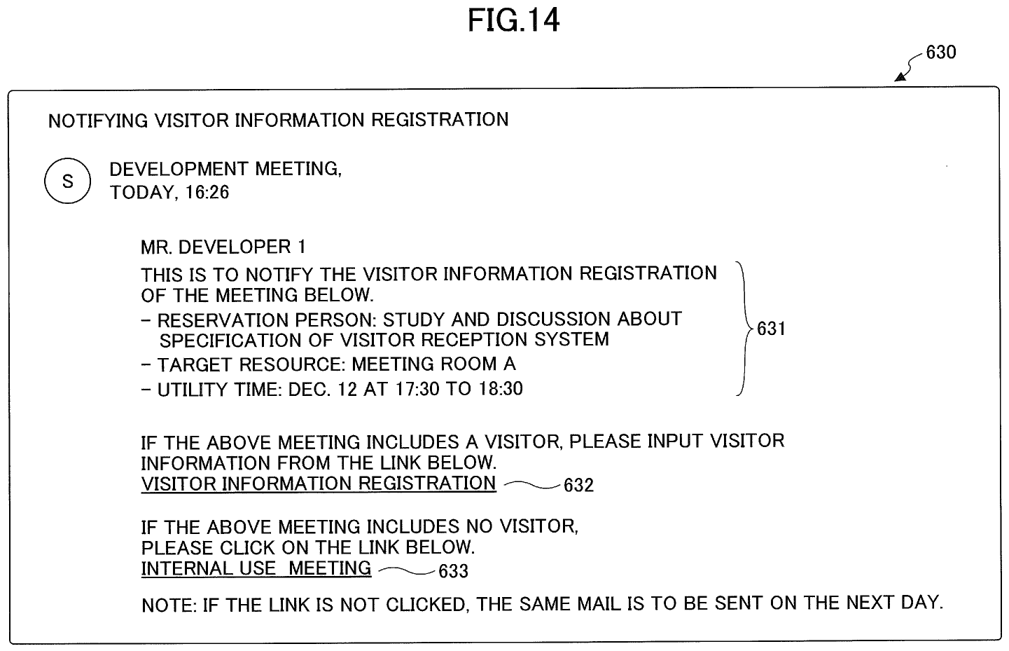

S22: The communication unit 61a of the terminal device 60 receives the e-mail 630 and the display control unit 61c displays the e-mail 630 on the display 506 (see FIG. 14). The e-mail 630 includes the URL of the visitor information registration screen 640. When the reservation person depresses the URL, the operation reception unit 61b accepts the depressing of the URL.

S23: The communication unit 61a of the terminal device 60 requests the meeting management server 30 to send the visitor information registration screen 640. The receiving unit 31b of the meeting management server 30 receives the request.

S24: Accordingly, the workflow reception screen generation unit 122 generates the screen information of the visitor information registration screen 640, and the sending unit 31a sends the screen information of the visitor information registration screen 640 to the terminal device 60. The screen information of the visitor information registration screen 640 is generated from the progress management information.

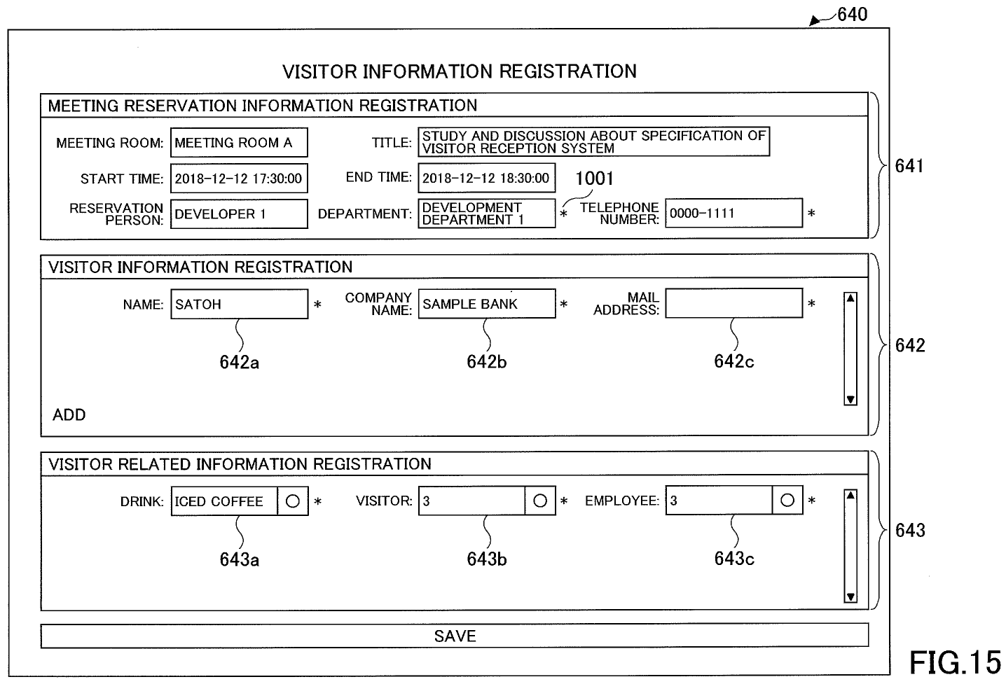

S25: The communication unit 61a of the terminal device 60 receives the screen information of the visitor information registration screen 640, and the display control unit 61c displays the visitor information registration screen 640 on the display 506 of the terminal device 60 (see FIG. 15). First, the reservation person enters the visitor information and visitor attribute information. The operation reception unit 61b receives visitor information and visitor attribute information.

S26: The communication unit 61a of the terminal device 60 sends the visitor information and the visitor attribute information to the meeting management server 30.

S27: The receiving unit 31b of the meeting management server 30 receives the visitor information and the visitor attribute information, and the workflow reception screen generation unit 122 registers the visitor information and the visitor attribute information in the progress management information DB 132.

### <Example of E-Mail/Visitor Information Registration Screen>

FIG. 14 illustrates an example of a text surface of e-mail 630 and FIG. 15 illustrates an example of a visitor information registration screen 640. As illustrated in FIG. 14, the e-mail 630 includes reservation information based information 631, visitor URL link information 632, and internal use URL link information 633. The reservation information based information 631 is the information extracted from the reservation information from the progress management information. The visitor URL link information 632 is embedded with the URL of the visitor information registration screen 640. When the reservation person depresses it, the terminal device 60 can display the visitor information registration screen 640. Similarly, the internal use URL link information 633 is embedded with the URL of the registration screen of the internal meeting, and when the reservation person depresses, the terminal device 60 may display the registration screen of the internal meeting. The registration screen of the internal meeting is the screen for registering the information required for the internal meeting.

As illustrated in FIG. 15, the visitor information registration screen 640 includes a reserved information field 641, a visitor attribute entry field 642, and a visitor information entry field 643. In the reservation information field 641, the workflow reception screen generation unit 122 sets the reservation information of the progress management information DB 132. The reservation person cannot basically change the reservation information (grayed out, for example), but a part of the items (department and telephone number in FIG. 15) are added to the reservation information.

A visitor attribute entry field 642 is the field in which a reservation person enters a visitor attribute. The visitor attribute entry field 642 includes a name field 642a, a company name field 642b, and a mail address field 642c. The workflow reception screen generation unit 122 acquires items of visitor attribute information from the progress management information DB 132 and generates screen information of the visitor information registration screen 640 with these items left blank. The reservation person inputs a value in each field. The items in the visitor attribute entry field 642 may be set by the managing person in a manner similar to the visitor information entry field 643.

A visitor information entry field 643 is the field in which the reservation person inputs visitor information. The visitor information entry field 643 includes a drink field 643a, number of visitors field 643b, and number of employees field 643c. The workflow reception screen generation unit 122 acquires items of the visitor information from the progress management information DB 132 and generates screen information of the visitor information registration screen 640 while the items are empty. The reservation person inputs a value in each item.

As described above, the information input in the visitor information registration screen 640 is registered in the progress management information DB 132. In addition, whether each item of the visitor information registration screen 640 is mandatory is predetermined, and the mandatory item is displayed with a mark 1001, which is the asterisk “*”. If there is an omission in the mandatory item, the mail sending unit 123 repeatedly sends an e-mail 630 at a predetermined timing.

### <Process at Time of Reception Support>

In this way, the reservation person registers progress management information. The progress managing person 3 operates the progress management terminal 80 to display the progress management screen 650. Even if the reservation person does not register the progress management information, it is possible to display the progress management screen 650. In this case, the items not set by the reservation person is left blank.

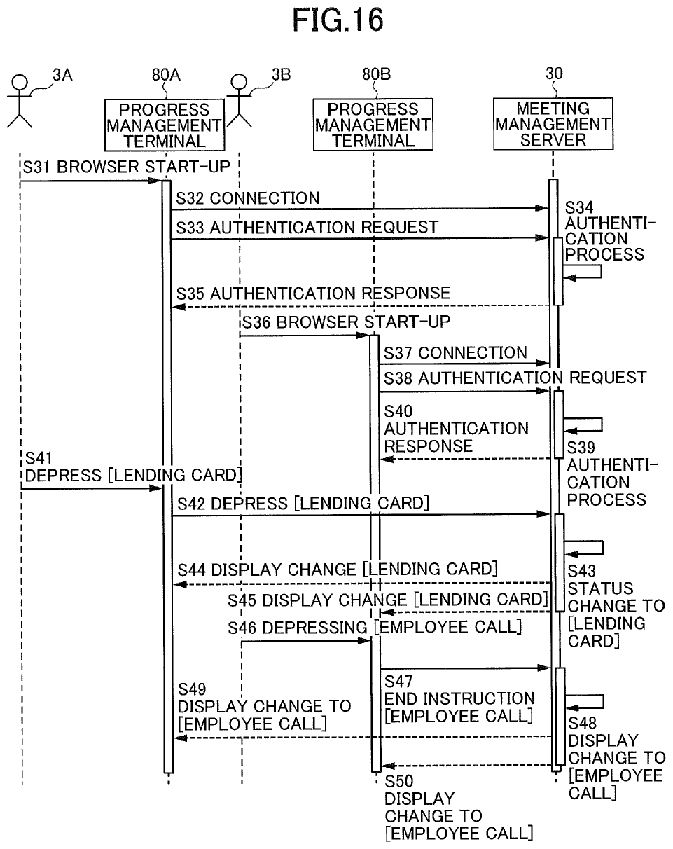

FIG. 16 is an example of a sequence diagram illustrating a procedure in which the progress management terminal 80 manages the progress of task in real time. In FIG. 16, a person who operates the progress management terminal 80A is referred to as a progress managing person 3A, and a person who operates the progress management terminal 80B is referred to as a progress managing person 3B.

S31: The progress managing person 3A operates the progress management terminal 80A to start up the browser software. When the browser software starts up, the communication unit 81, the operation reception unit 82, and the display control unit 83 are operated.

S32: When the progress managing person 3A operates, the communication unit 81 of the progress management terminal 80A communicates with the meeting management server 30.

S33: The progress managing person 3A logs in to the meeting management server 30 so that the progress management terminal 80 communicates an authentication request (e.g., a user name, a password) to the meeting management server 30.

The S34: The meeting management server 30 performs an authentication process to determine whether the authentication request has been successful. The authentication process may be performed in a publicly known manner. In the embodiment, the authentication is described as the successful authentication.

S35: The sending unit 31a of the meeting management server 30 sends the authentication response indicative of successful authentication to the progress management terminal 80A. Accordingly, the progress managing person 3A can display a progress management screen 650, and the display control unit 83 of the progress management terminal 80A displays the progress management screen 650. The progress management terminal 80A displays the progress management screen 650 is retained by the screen information sending unit 126 of the meeting management server 30.

S36 to S40: The progress managing person 3B operates in a manner similar thereto, and the display control unit 83 of the progress management terminal 80B displays the progress management screen 650. The display of the progress management screen 650 on the progress management terminal 80B is retained by the screen information sending unit 126 of the meeting management server 30. Therefore, the progress management terminals 80A and 80B log in and display the same screen based on the reservation information.

S41: A certain meeting participant stops at a location 5 of the progress managing person 3A, and the progress managing person lends a card indicating that the certain meeting participant is permitted to enter the facility. The progress managing person 3A clicks a phase of “lending card” on the progress management screen 650. The operation reception unit 82 receives a depression of the phase of “lending card”.

S42: The communication unit 81 of the progress management terminal 80 sends an issue that “lending card” has been pressed (identification information of the phase of “card lending”) to the meeting management server 30 together with the reserved ID.

S43: The receiving unit 31b in the meeting management server 30 receives the issue that “card lending” has been depressed, and the progress management unit 124 registers “done” in “card lending” of the progress management information identified by the reservation ID of the progress management information DB 132.

S44: Because the progress management unit 124 updates the progress management information DB 132 (because the progress of the task is updated), the progress management screen generation unit 125 generates the progress management screen 650 that was updated after the “card lending” card was done. Specifically, the color of the phase of “lending card” phase is changed. The screen information sending unit 126 sends the screen information of the updated progress management screen 650 to the progress management terminal 80A in response to the fact that “card lending” has been depressed.

S45: The screen information sending unit 126 sends the screen information of the updated progress management screen 650 to the progress management terminal 80B in response to the polling or by push communication. That is, the screen information sending unit 126 sends the screen information of the updated progress management screen 650 to the progress management terminal 80B displaying the progress management screen 650. In this way, each progress managing person 3 can manage the progress of the task in real time.

S46: Next, because a certain meeting participant stops at the location 5 of the progress managing person 3B, the progress managing person 3B call up an employee who is one of the meeting participants. The progress managing person 3B clicks a phase of “employee call” on the progress management screen 650.

S47: The communication unit 81 of the progress management terminal 80B sends an issue that “employee call” is depressed (identification information of the phase of “employee call”) to the meeting management server 30 together with the reservation ID.

S48: The receiving unit 31b of the meeting management server 30 receives an issue indicating that “employee recall” has been depressed and a reservation ID and registers “done” in “employee recall” of the progress management information identified by the reservation ID of the progress management information DB 132. Because the progress management unit 124 updates the progress management information DB 132 (because the progress of the task has been updated), the progress management screen 650, which has been updated, is generated by the progress management screen generation unit 125. Specifically, the color of the phase of “employee call” is changed.

S49: The screen information sending unit 126 sends the screen information of the updated progress management screen 650 to the progress management terminal 80A in response to the polling or by push communication.

S50: The screen information sending unit 126 sends the screen information of the updated progress management screen 650 to the progress management terminal 80B in response to the issue that “employee call” is depressed.

Said differently, the screen information sending unit 126 sends the screen information of the updated progress management screen 650 to the progress management terminal 80 displaying the progress management screen 650. In this way, each progress managing person 3 can manage the progress of the task in real time.

### <Example of Progress Management Screen>

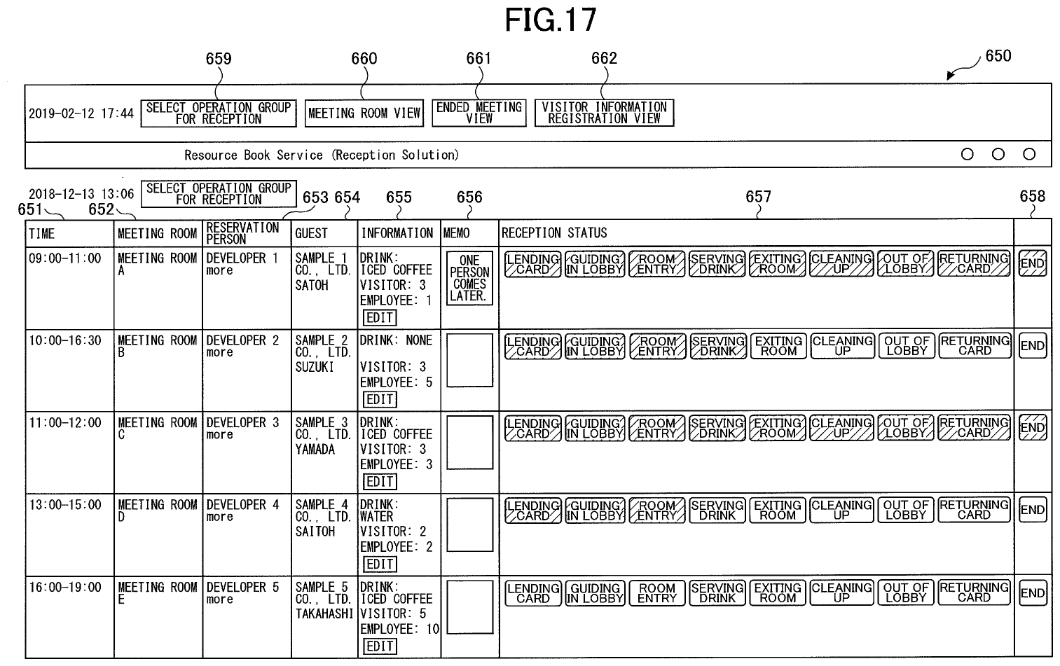

FIG. 17 is a diagram illustrating an example of the progress management screen 650. The progress management screen 650 includes items of a time 651, meeting room 652, reservation person 653, guest 654, information 655, memo 656, reception status 657, and end button 658. A time 651 is a start time and end time of the progress management information (reservation information). The meeting room 652 is also a meeting room name. The reservation person 653 is the name of the employee that is associated with the reservation person account using the employee information. The guest 654 is visitor attribute information of progress management information. The information 655 is visitor information of the progress management information. The memo 656 is a field for the progress managing person 3 to arbitrarily write down information. The reception status 657 is the reception workflow for progress management information.

Each phase of the reception workflow is arranged like buttons in the reception status 657. The progress managing person 3 enters the progress of the task by depressing the phase. When a certain phase is depressed, the progress management screen generation unit 125 changes the color of the button of the pressed phase so that the progress managing person 3 can grasp the progress of the task at a glance. In addition to the colors of the phase buttons, the shapes and/or brightness of the phase buttons may be changed, or the brightness may be changed, or the ended phases may be erased. The display mode may be changed so as to be visually recognized.

Each phase is displayed in the chronological order of the task. This order follows when the phase registration screen 620 is registered. The order in which each phase is depressed may be determined for each phase combination. For example, there may be a restriction before and after the depressing such that the phase cannot be depressed if the room entry is not depressed. On the other hand, no such restriction is set for phases that are strictly unrelated to each other, thereby facilitating the task of the progress managing person 3 to be performed.

The end button 658 is a button for preventing the information for one meeting from being displayed on the progress management screen 650. Said differently, because all phases of the reception status has been completed, when it is no longer necessary for the progress managing person 3 to manage, the end button 658 can be depressed not to display, and it is possible to prevent the progress management information from being continuously displayed.

The progress management screen 650 further includes an operation rule selection button 659, a meeting room view button 660, an ended meeting view button 661, and a visitor information registration view button 662. These are discussed later.

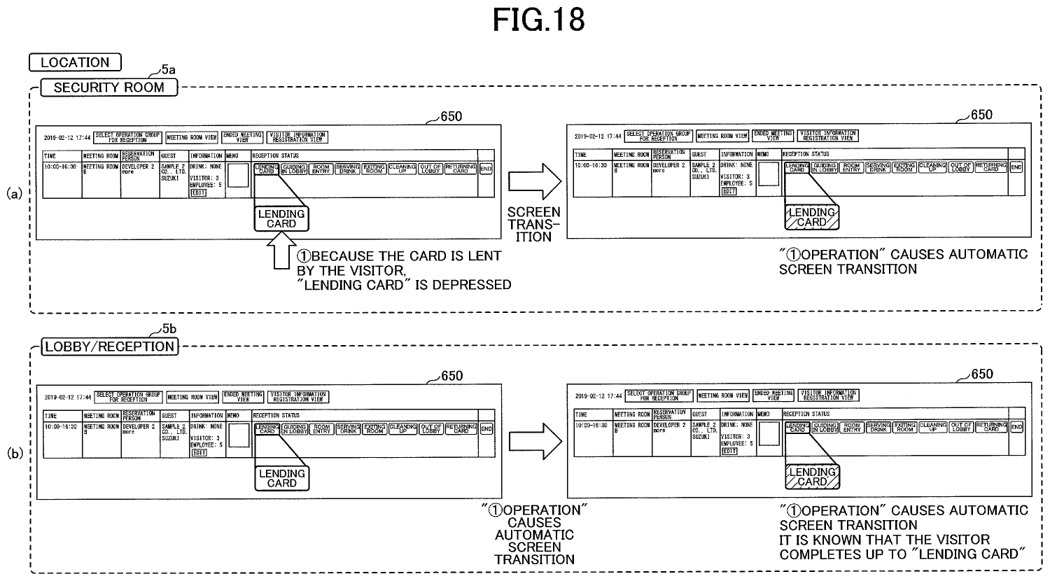

FIG. 18 is a diagram illustrating the progress management screen 650 updated when the phase of the reception workflow is clicked. FIG. 18(a) illustrates the progress management screen 650 displayed by the progress management terminal 80 of the security room 5a, and FIG. 18(b) illustrates the progress management screen 650 displayed by the progress management terminal 80 of the lobby/reception 5b.

As illustrated in FIG. 18(a), a card is lent to the visitor in the security room 5a and the progress managing person 3 clicks “lending card” on the progress management screen 650. As a result, the button of the “lending card” phase of the progress management screen 650 displayed by the progress management terminal 80 of the security room 5a is changed.

Further, as illustrated in FIG. 18(b), the color of the buttons of the phase of “lending card” of the progress management screen 650 displayed by the progress management terminal 80 of the lobby/reception 5b automatically changes to approximately the same time as the progress management screen 650 displayed by the progress management terminal 80 of the security room 5a.

### <Updating Progress Management Screen by Operation of Meeting Room Terminal>

In the above explanation, the progress management terminals are synchronized with each other in real time to update the screens. However, the meeting management server 30 can update the progress management screen 650 of each progress management terminal 80 in real time even when the participant operates the meeting room terminal 90. The meeting room terminal 90 displays the standby screen and receives a check-in and check-out by the participant and sends a check-in request and a check-out request to the meeting management server 30. As a result, the status of the meeting management information DB 493 is changed. However, because the information synchronization unit 121 of the reception support web application 120 acquires the status, the phase of “room entry” corresponding to check-in of the progress management information DB 132 or “exiting room” corresponding to the check-out of the progress management information DB 132 is updated. Because the progress management information DB 132 is updated, the progress management screen generation unit 125 generates the screen information of the progress management screen 650, and the screen information sending unit 126 sends the screen information of the progress management screen 650 to each progress management terminal displaying the progress management screen 650.

### <Standby Display>

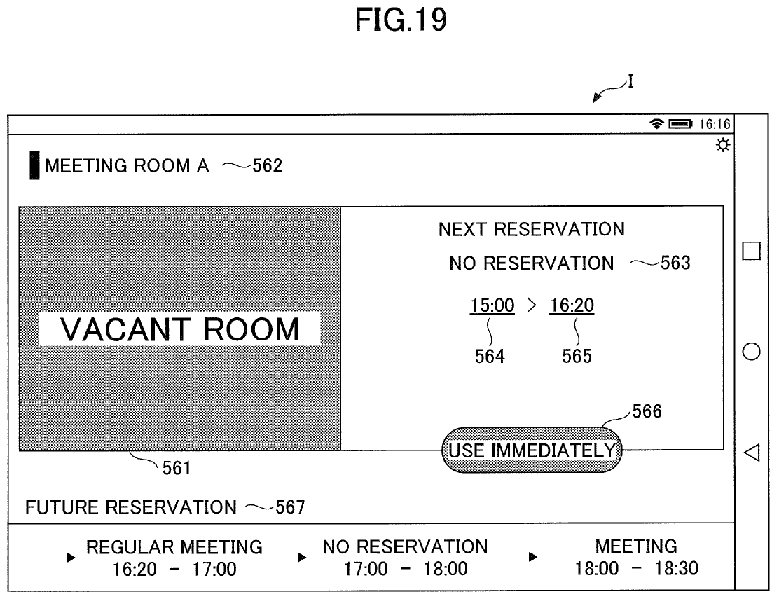

First, a standby screen will be described with reference to FIGS. 19 to 21. FIG. 19 illustrates an example of a standby screen I displayed by the meeting room terminal 90 when the meeting room is currently vacant. In the standby screen I of FIG. 19, a current status field 561, meeting room name field 562, meeting name field 563, start time field 564, end time field 565, use start button 566, and subsequent reservation field 567 are displayed.

A current status field 561 illustrates the situation of the meeting room at present time. The display control unit 94 of the meeting room terminal 90 displays the status of the reservation information in the current status field 561. When there is no reservation information reserved at the present time, the display control unit 94 displays “vacant room” (until the next reservation can be checked in) or “ready for room entry” (after the next reservation can be checked in) in the current status field 561.

A meeting room name stored in the storage unit 99 is displayed in the meeting room name field 562. The meeting name field 563 displays a meeting room name included in a reservation information. Until the next reservation can be checked in, the display control unit 94 displays “no reservation” in the meeting name field 563.

A start time and end time 565 included in the reservation information are displayed in the start time field 564 and the end time field 565. Because FIG. 19 illustrates a standby screen at a time range when there is no reservation, the start time of the next meeting and the end time of the last meeting are respectively displayed in the start time field 564 and the end time field 565.

The subsequent reservation field 567 displays the start time and end time of each meeting that are scheduled later than the present time according to the reservation information. The use start button 566 is displayed when the current status field 561 is “vacant”. The user can start using the meeting room by depressing a use start button 566 without reserving the meeting room. Depressing this button is sent to the meeting management server 30 and the reservation management server 20 to change the status of the meeting room in the reservation information. The status change is also reflected on the standby screen when the meeting room terminal 90 receives reservation information.

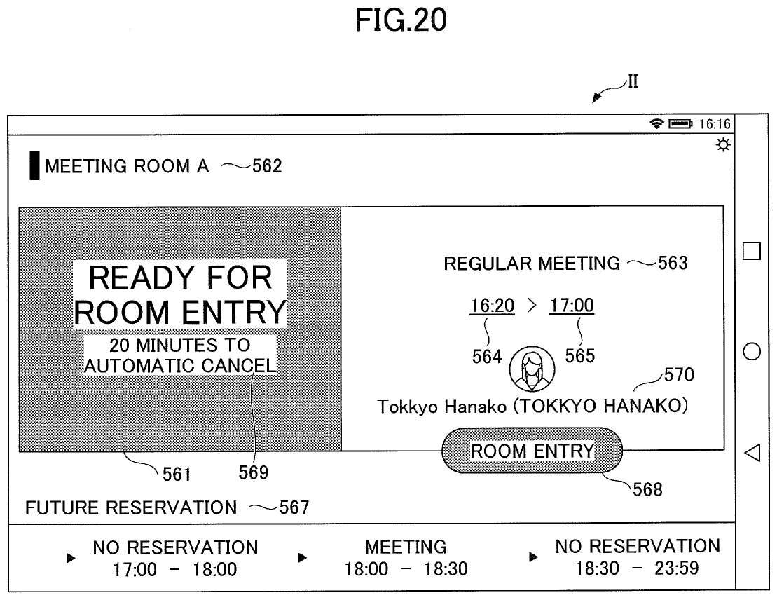

FIG. 20 illustrates an example of a standby screen II displayed by the meeting room terminal 90 when a meeting room is currently vacant but within a predetermined time until the start time of the next meeting. In the standby screen II of FIG. 20, the current status field 561 indicates “ready for room entry” and the room entry button 568 is displayed. The reservation person is displayed in the reservation person name field 570. When the status of the reservation information changes to a “check-in possible” or the like, the display control unit 94 displays “ready for room entry” and displays the room entry button 568.

For example, 10 minutes before the start time, the status changes to “check-in possible” or the like. Therefore, the display control unit 94 displays “ready for room entry” and permits check-in. That is, the reservation person can check in. Further, the check-in management unit 38 of the meeting management server 30 determines that the check-in is not detected if the meeting room terminal 90 does not send the check-in request by a predetermined time and automatically cancels the check-in request. Therefore, the display control unit 94 counts down the time 569 until the automatic cancellation and displays the current status field 561. The time that is automatically cancelled, for example, is 10 minutes after the start time.

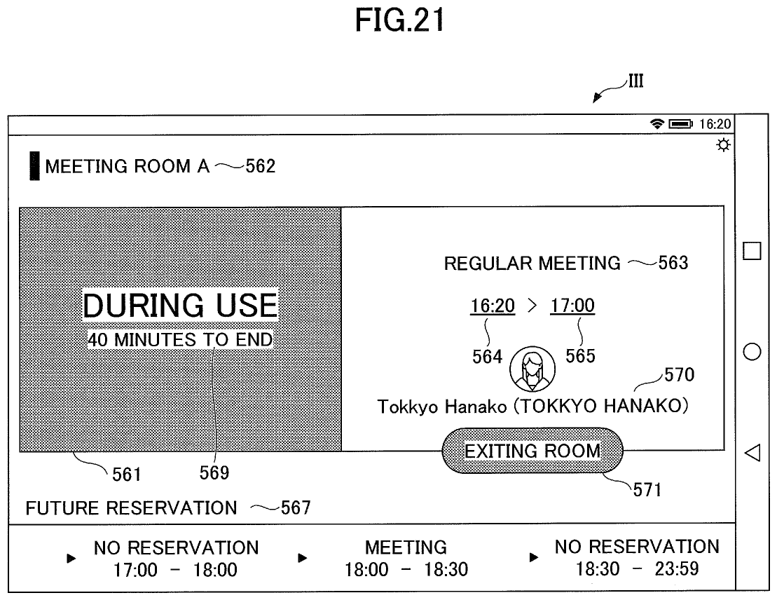

The entry button 568 is a button for the user to check in. Depressing of this button allows the reservation person to input the meeting identification information. When the meeting identification information is sent to the meeting management server 30 and the meeting identification information registered in the meeting identification information DB 494 is matched, the status of the meeting management information DB 493 is checked in, and the status changes to the standby screen III of FIG. 21.

Reservation person information is displayed in a reservation person name field 570. The reservation person may be an account included in the reservation information, or a reservation person's name or nickname may be sent from the meeting management server 30. It is also possible to display a photo of the reservation person or a character that represents the reservation person.

FIG. 21 illustrates an example of the standby screen III displayed by the meeting room terminal 90 when the meeting room is currently during use. In the standby screen III of FIG. 21, the current status field 561 indicates “during use” and the room exit button 571 is displayed. When the reservation person checks in, the status of the meetings management information DB 493 is “check-in completed”. When the meeting room terminal 90 receives the reservation information, the display control unit 94 detects that the status is in check-in completed. The display control unit 94 displays the current status field 561 as “during use” and displays the room exit button 571 until it is checked out. The display control unit 94 counts down the time until the end time and displays the current status field 561. The exit button 571 is a button for the reservation person to check out. When this button is depressed, a check-out request is sent to the meeting management server 30, and the check-in management unit 38 of the meeting management server 30 updates the status of the meeting management information DB 493 to “check-out done”. When the meeting room terminal 90 receives the reservation information, the display control unit 94 displays “vacant room” or “ready for room entry” in the current status field 561.

### <Operation Procedure>

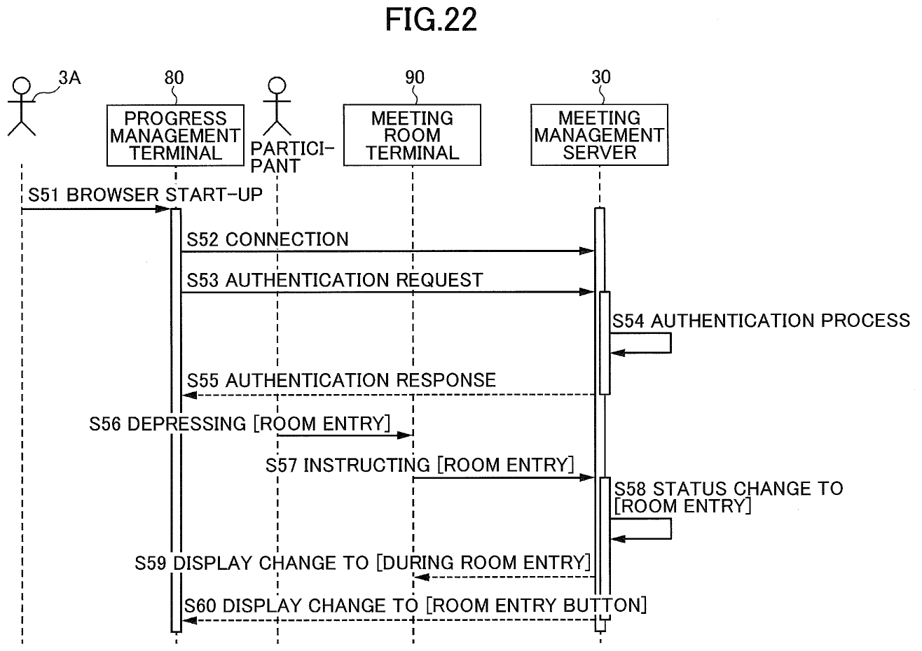

FIG. 22 is an example of a sequence diagram illustrating a procedure in which the progress management screen 650 of the progress managing person 3 is updated when the participant operates the meeting room terminal 90.

Steps S51 to S55: Like steps S31 to S35 of FIG. 16, the display control unit 83 of the progress management terminal 80 displays the progress management screen 650. Displaying of the progress management screen 650 in the progress management terminal 80 is held by the screen information sending unit 126 of the meeting management server 30.

S56: A participant depresses the entry button 568 of the meeting room terminal 90 for check-in. The operation reception unit 93 of the meeting room terminal 90 receives the clicking of the entry button 568 and the meeting identification information input by the participant.

S57: The server communication unit 91 of the meeting room terminal 90 sends the reservation ID, the check-in request, and the meeting identification information to the meeting management server 30. The reservation ID is sent from the meeting management server 30 together with the reservation information displayed by the meeting room terminal 90.

S58: The receiving unit 31b of the meeting management server 30 receives the reservation ID, the check-in request, and the meeting identification information, and the check-in management unit 38 permits the check-in when the combination of the meeting room ID and the meeting identification information sent by the meeting room terminal 90 is registered in association with the reservation ID of the meeting identification information DB 494. Here, it is assumed that the check-in is permitted. The check-in management unit 38 changes the status of the meeting management information DB 493 to “check-in completed”. The information synchronization unit 121 acquires the reservation ID of the meeting management information whose status has been updated and the status after the update from the reservation management web application 110 and identifies the progress management information using the reservation ID. The progress management unit 124 updates the phase of “room entry” of the reception workflow in the progress management information DB 132 corresponding to the “check-in.”

Because the progress management unit 124 updates the progress management information DB 132 (because the progress of the task has been updated), the progress management screen 650 whose “entry” is “done” is generated by the progress management screen generation unit 125. Specifically, the color of the phase of “room entry” is changed.

S59: Because the meeting management server 30 sends the reservation information whose status has changed in response to the request of the reservation information to the meeting room terminal 90, the standby screen of the meeting room terminal 90 is changed during room entry.

S60: The screen information sending unit 126 sends the screen information of the updated progress management screen 650 to the progress management terminal 80 in response to the polling or by push communication. That is, the screen information sending unit 126 sends the screen information of the updated progress management screen 650 to the progress management terminal 80 displaying the progress management screen 650.

Because the communication unit 81 of the progress management terminal 80 receives the screen information of the progress management screen 650 and the display control unit 83 updates the progress management screen 650, each progress managing person 3 can manage the progress of task in real time.

When the participant checks out of the meeting room terminal 90, the status of the meeting management information DB 493 is updated to the check-out done, and the phase of “exiting room” of the progress management information DB 132 corresponding to the “check-out” is registered. Similarly, each progress management terminal 80 can update the progress management screen 650.

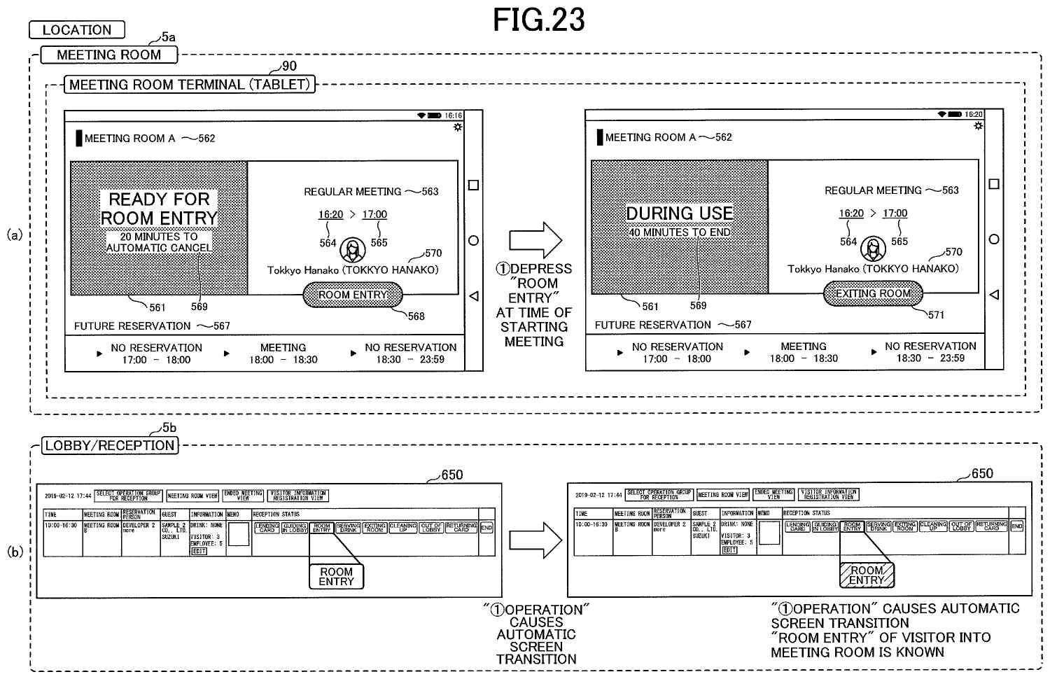

FIG. 23 is a diagram illustrating a progress management screen 650 updated when an entry button is depressed by the meeting room terminal 90. FIG. 23(a) illustrates the standby screen displayed by the meeting room terminal 90 of the meeting room, and FIG. 23(b) illustrates the progress management screen 650 displayed by the progress management terminal 80 at the lobby/reception 5b. FIG. 23(b) may be the progress management screen 650 displayed by the progress management terminal 80 of the security room 5a.

As illustrated in FIG. 23(a), when the entry button 568 is depressed, the standby screen II transitions to the standby screen III.

Further, as illustrated in FIG. 23(b), the color of the button of the phase of “room entry” of the progress management screen 650 displayed by the progress management terminal 80 of the lobby/reception 5b automatically changes to substantially the same time as the time when the standby screen II transitions to the standby screen III.

As described above, the progress management system 100 according to this embodiment can reflect the operation of the meeting room terminal 90 in real time on the progress management screen 650 displayed by the progress management terminal 80. Therefore, the progress managing person 3 can manage the progress of the task in real time with the browser software.

### <Selection Button of Operation Rule of Progress Management Screen, Meeting Room View Button, Ended Meeting View, Visitor Information Registration View>

Next, a selection button 659 of operation rule of progress management screen, meeting room view button 660, ended meeting view button 661, visitor information registration view button 662 illustrated in FIG. 17 will be described. The operation rule selection button 659 is a button for the progress managing person 3 to select the operation rule. As shown in Table 10, for each operation rule, the visitor information and reception workflow are registered in the workflow setting information DB 131. The progress managing person 3 can display a list of the progress management information in the meeting room to which the same operation rule applies as the progress management screen 650.

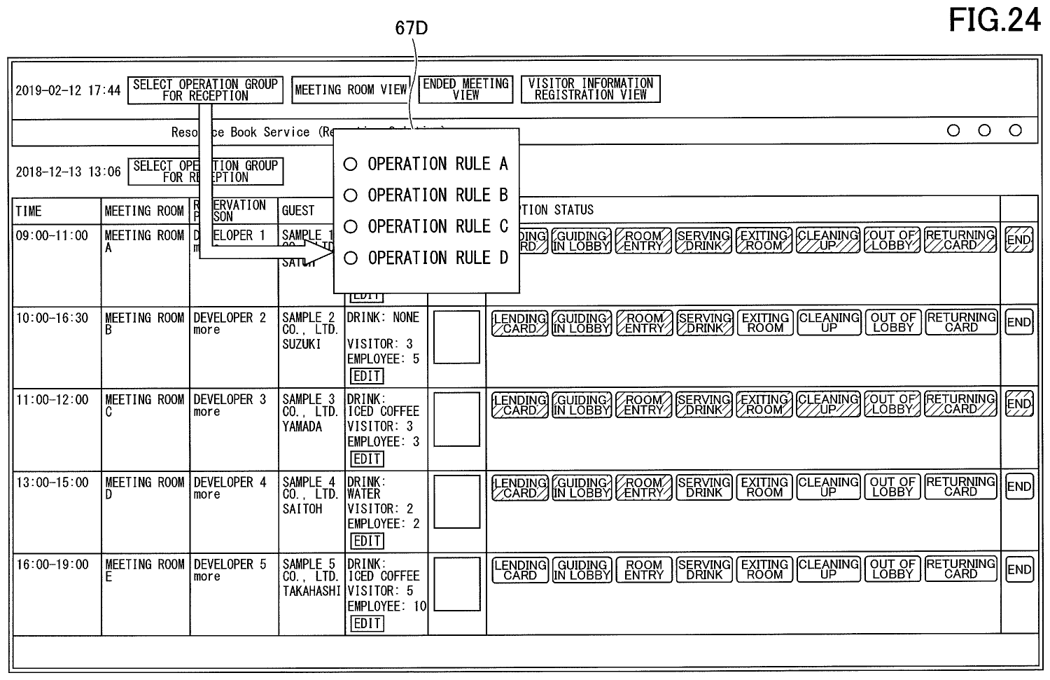

FIG. 24 is an example of the operation rule selection screen 670 displayed when the operation rule selection button 659 is depressed. In FIG. 24, the operation rule selection screen 670 is superimposed on the progress management screen 650. It is permitted to transition to another screen.

Returning to the explanation in FIG. 17. The ended meeting view button 661 is a button that displays a list of progress management information for which the end button 658 is depressed. That is, a list of ended meetings (reservations) can be displayed. The configuration of the screen may be the same as that of the progress management screen 650 illustrated in FIG. 17.

A visitor information registration view button 662 is a button for displaying the visitor information registration screen 640 or a screen equivalent thereto. Accordingly, the progress managing person 3 may display the visitor information registration screen 640 and register the visitor information.

The meeting room view button 660 is a button for changing a display format of the progress management information from that of FIG. 17. For convenience, the display format of FIG. 17 is called a reservation view. The progress management screen 650 of the reservation view displayed the progress for each reservation information. In contrast, the meeting room view displays the progress for each meeting room.

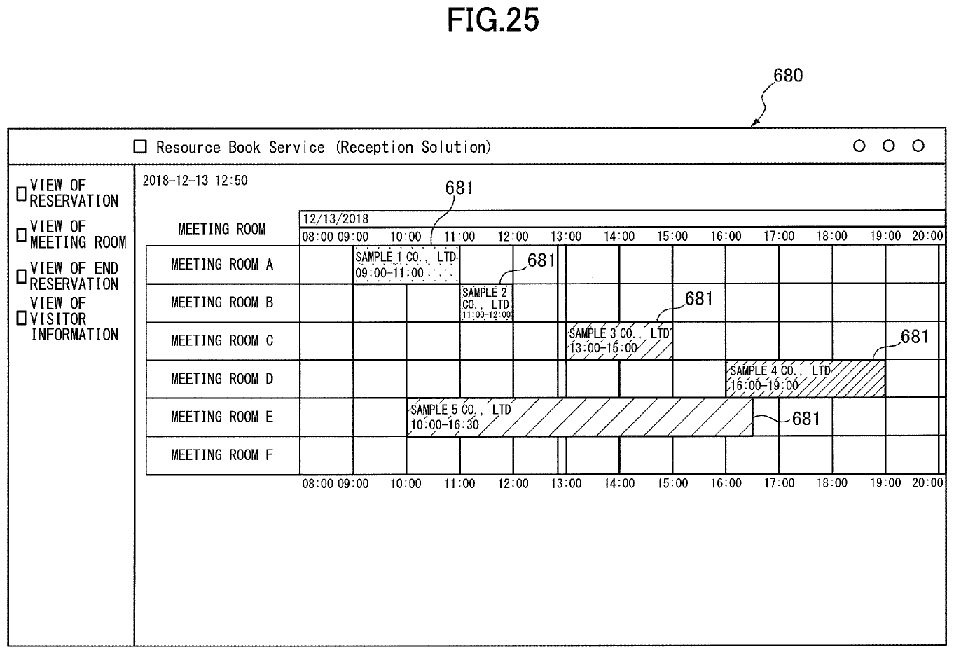

FIG. 25 is an example of a progress situation screen 680 displayed in a meeting room view. As illustrated in FIG. 25, the progress screen 680 shows the time zone at which reservations are made for each meeting room, with rectangular display components 681. Display component 681 displays the start time and end time of the meeting and the name of the meeting. This makes it easy to understand the reservation status for each meeting room.

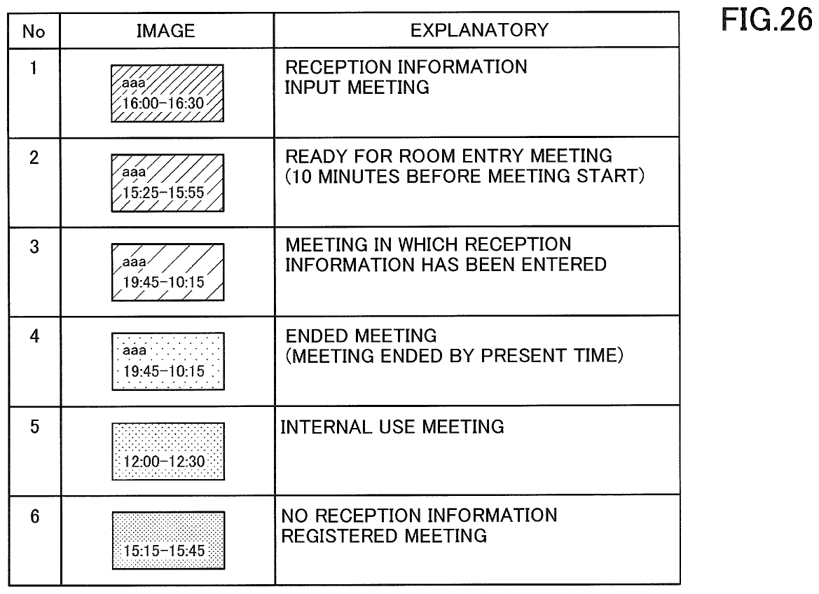

The display component 681 represents the progress of the task in color. FIG. 26 illustrates an example of the relationship between color and work progress. In FIG. 26 shows colors by type of diagonal due to the nature of the plot. Progress has been subdivided into six stages because of the color of the progresses are indicated by colors.
No. 1: Green: Reception information input meeting

A meeting for which mandatory visitor information has been entered.
No. 2: Blue: Ready for room entry meeting (10 minutes until meeting starts)

This is a meeting that can be checked in but has not yet been checked in.
No. 3 Red: Meeting in which reception information has been entered

The meeting in which check-in has been completed.
No. 4: Gray 1: Ended meeting

This is a meeting that has been ended by the current time.
No. 5: Gray 2: Internal use meeting

It is a meeting with no external visitor.
No. 6: Purple: No reception information registered meeting

A meeting at which an input of mandatory visitor information or visitor attribute information has not been completed.

The progress management screen generation unit 125 determines a color whose progress corresponds to the phase of the progress management information DB 132 based on FIG. 26. In this case, the progress management information DB 132 corresponds to the phases Nos. 1 to 6. The six steps of the colors are an example. If the color is changed for each phase, no association between No. and colors is required.

In this way, the progress of the reception task is displayed in color for each meeting room, making it easier for the progress managing person 3 to understand the progress of each meeting room.

In addition, the progress managing person 3 may be able to input the progress from the progress situation screen 680 of FIG. 25. For example, if the display component 681 is right-clicked, the phase is displayed in a pulldown menu and the phase after progress can be selected.

### <Use Case>

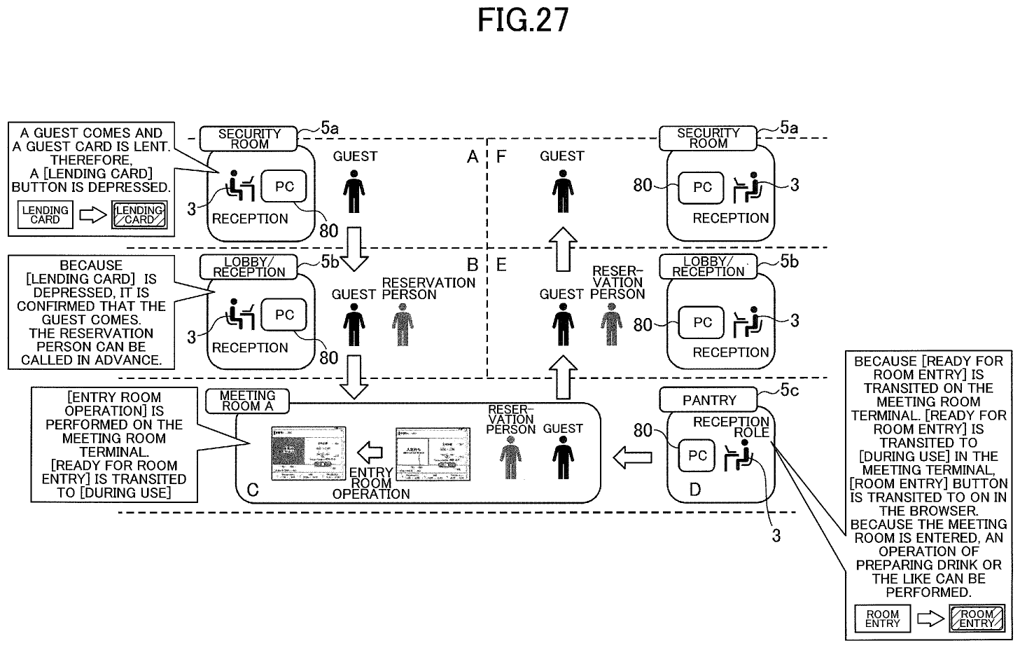

FIG. 27 is a diagram illustrating a use case of the progress management system 100.

A. Visitor stops at the security room 5a. Because the progress managing person 3 in the security room 5a lends a card, the phase of “lending card” of the progress management screen 650 is depressed.

B. The progress management screen 650 displayed by the progress management terminal 80 of the lobby/reception 5b also changes the color of the phase “lending card”. This allows the progress managing person 3 in the lobby/reception 5b to confirm the arrival of the visitor and call the reservation in advance. The reservation persons join the visitor.

C. The visitor and reservation person who arrive in the meeting room depress the room entry button 568 of the meeting room terminal 90. As a result, the standby screen becomes during use, and the color of the phase of “room entry” of the progress management screen 650 for the progress managing person in, for example, the security room 5a, the lobby/reception 5b, and the pantry (room with tableware, food, and a simple sink) 5c is changed.

D. The progress managing person of the pantry 5c starts serving drink to confirm that the visitor and so on have entered the meeting room.

E. After the meeting, the visitor and reservation person depress the room exit button 571 of the meeting room terminal 90. This causes the standby screen to display ready for room entry or vacant room, and changes the color of the phase of “exiting room” of the security room 5a, the lobby/reception screen 5b, and the progress management screen 650 of the pantry 5c. The progress managing person in the pantry 5c begins to clean up the meeting room as it is known that the visitors and so on have gone out. When the visitor stops at the lobby/reception 5b, the color of the phase “out of lobby” in the progress management screen 650 in the security room 5a, the lobby/reception 5b, and the pantry 5c changes.

F. Visitor stops at security room 5a The progress managing person 3 depresses “returning card” on the progress management screen 650 in order for the visitor to return the card to the security room 5a. The color of the phase of “returning card” of the progress management screen 650 in the security room 5a, the lobby/reception 5b, and the pantry 5c change.

### SUMMARY

As described above, in the reception task of using the meeting room, even if the progress management terminal 80 at each location uses the browser software, the progress management terminal 80 at each location may reflect the progress of the task on the progress management screen in real time because the meeting management server 30 sends the progress in response to the polling or by push communication to the progress management terminal 80 displaying the progress management screen 650.

Further, even when the meeting room terminal 90 is operated by a participant, the progress management terminal 80 using the browser software can be reflected in real time.

### OTHER APPLIED EXAMPLES

While the preferred embodiment of the present embodiment has been described with reference to examples, various modifications and substitutions may be made thereto without departing from the spirit and scope of the disclosure.

For example, there may be a plurality of meeting management servers 30, or the functions of the meeting management server 30 may be distributed among a plurality of servers. The reservation management server 20 and the meeting management server 30 may be integrated.

The progress management system 100 of the present embodiment may also be referred to as a web service. The web service is a variety of services provided through the application of Internet-related technology. Examples include meeting room rental services and various rental services. A system that uses the web service is called a use system.

Further, the examples of the structures in FIGS. 6 and 7 illustrated in the above-described embodiment is divided according to the main functions for easier understanding of the processing of the progress management system 100. However, the embodiment is not limited by a method of dividing processing units or the name of each processing unit. The progress management system 100 may be divided into more processing units depending on the processing content. Alternatively, one processing unit can be divided so as to include more processes.

The functions of the embodiments described above may be implemented by one or more processing circuits. Here, the “processing circuit” includes a processor programmed to perform each function by software, such as a processor implemented in an electronic circuit, and a device such as an ASIC (Application Specific Integrated Circuit), a digital signal processor (DSP), a field programmable gate array (FPGA), or a conventional circuit module, which are designed to perform each function as described above.

It is possible to provide a progress management system that can manage the progress of the tasks in real time with a browser software.

### EXPLANATION OF REFERENCE SYMBOL

10: chat server
20: reservation management server
30: meeting management server
60: terminal device
70: electronic device
90: meeting room terminal
100: progress management system

What is claimed is:

1. A progress management system in which a plurality of progress management terminals that execute browser software and an information processing apparatus communicate with each other,
when an update of a progress is received on a screen related to the progress of a task displayed by the browser software of one of the progress management terminals, the one of the progress management terminals sends an issue that the progress is updated to the information processing apparatus,
the information processing apparatus, when the issue that the progress is updated is received, reflects the issue that the progress is updated on other one or ones of the progress management terminals that display a same screen as that of the one of the progress management terminals using bidirectional communications, and
browser software of the other one or ones of the progress management terminals automatically update the same screen as that of the one of the progress management terminals.

2. The progress management system according to claim 1, wherein
the screen related to the progress of the task displays a plurality of phases obtained by subdividing the task,
the one of the progress management terminals receives a selection of the phase to receive the update of the progress and sends identification information of the phase, of which selection is received, to the information processing apparatus,
the information processing apparatus updates the screen relating to the progress of the task and sends screen information of the screen to the other one or ones of the progress management terminals based on the identification information of the phase, and
the browser software of the other one or ones of the progress management terminals automatically update a display mode of the phase, of which the selection is received by the one of the progress management terminals based on the screen information sent from the information processing apparatus.

3. The progress management system according to claim 1, the progress management system comprising:
an information processing terminal communicating with the information processing apparatus,
wherein, when an operation related to the progress of the task is received on a screen displayed by application software activated on the information processing terminal, the information processing terminal sends an issue that the operation related to the progress of the task is performed to the information processing apparatus, and
wherein the information processing apparatus, upon receipt of the issue that the operation related to the progress of the task is performed, reflects the issue that the progress is updated on at least one of the progress management terminals that display the screen related to the progress of the task, and
the browser software of the progress management terminals automatically updates the screen related to the progress of the task.

4. The progress management system according to claim 3, wherein
the task is related to a reception of a reserved resource,
the screen displayed by the application software displays a button to start using the resource,
the information processing terminal receives a depressing of the button to receive the updating of the progress and send an issue that the button is depressed to the information processing apparatus,
the information processing apparatus determines the progress corresponding to the button, updates the screen related to the progress of the task and sends the screen information of the screen to the progress management terminal,
the browser software of the progress management terminal displays a plurality of phases in which the task is subdivided as the screen related to the progress of the task, and
the information processing terminal automatically updates, based on the screen information sent from the information processing apparatus, a display mode of the phase corresponding to the depressing of the button, of which selection is received by the information processing terminal.

5. The progress management system according to claim 2, wherein the information processing apparatus,
sends the screen information of the phase registration screen that receives the registration of the phase to the registration terminal and receives the registration of the phase from the registration terminal, and
generates the screen information, with which the received phase is displayed on the screen related to the progress of the task and sends the generated screen information to the progress management terminal.

6. The progress management system according to claim 5, wherein
the task is related to the receiving of the reserved resource, the screen information of visitor information registration screen that receives the registration of an item of visitor information related to a visitor using the resource is sent to the registration terminal and the registration of the item of the visitor information is received from the registration terminal, and
the screen information for displaying the item of the received visitor information is generated on the screen related to the progress of the task and the generated visitor information is sent to the progress management terminal.

7. The progress management system according to claim 6, wherein
the item of the visitor information is stored in association with the reservation information of the resource,
an e-mail containing a URL of the screen for receiving the registration of the visitor information is sent to the reservation person included in the reservation information,
when the terminal device receives depressing of the URL included in the e-mail, the screen that receiving the registration of the visitor information is displayed,
when the visitor information received by the terminal device is sent to the information processing apparatus, the visitor information is registered in the item of the visitor information associated with the reservation information, and
the information processing apparatus generates the screen information that displays the visitor information is displayed on the screen related to the progress of the task and sends the generated screen information to the progress management terminal.

8. The progress management system according to claim 2, wherein
the task is related to the receiving of the reserved resource,
the information processing apparatus sends to the progress management terminal screen information of a screen, which transitions from the screen related to the progress of the task in response to a request from the progress management terminal and displays a time range reserved for each resource,
the one of the progress management terminals receives the selection of the phase to receive the updating of the progress of the task related to the receiving of the resource and sends the resource, for which the selection is received, and the identification information of the phase to the information processing apparatus,
the information processing apparatus generates the screen information for changing the display mode of the time range reserved for each of the resources based on the resource and the identification information of the phase and sends the screen information to the other one or ones of the progress management terminals, and
the browser software of the other one or ones of the progress management terminals changes the display mode of the time range reserved for each of the resources based on the screen information.

9. The progress management system according to claim 7, wherein
the task is related to the receiving of the reserved resource,
the information processing apparatus
sends the screen information of the phase registration screen for accepting the registration of the phase to the registration terminal and receives the registration of the phase from the registration terminal,
sends the screen information of the visitor information registration screen for receiving the registration of the item of the visitor information related to the visitor using the resource and
receives the registration, of the item of the visitor information from the registration terminal,
the phase and the item of the visitor information are stored in association with an operation rule of how to operate the resource,
when the reservation information of the resource is acquired, the item of the phase specified based on the operation rule of the resource and the item of the visitor information specified based on the operation rule of the resource are stored in association with the reservation information, and
the screen information for displaying the visitor information, the phase, and the reservation information on the screen related to the progress of the task is generated and sent to the progress management terminal.

10. A progress management method performed by a progress management system in which a plurality of progress management terminals that execute browser software and an information processing apparatus communicate with each other, progress management method comprises:
a step of sending, by the one of the progress management terminals, an issue that the progress is updated to the information processing apparatus, when an update of a progress is received on a screen related to the progress of a task displayed by the browser software of one of the progress management terminals;
a step of reflecting, by the information processing apparatus, the issue that the progress is updated on other one or ones of the progress management terminals that display a same screen as that of the one of the progress management terminals using bidirectional communications; and
a step of automatically updating, by the browser software of the other one or ones of the progress management terminals, the same screen as that of the one of the progress management terminals.

11. An information processing apparatus communicating with a plurality of progress management terminals that execute browser software,
the information processing apparatus receiving an issue that is received by one of the progress management terminals as indicating the progress is updated onto a screen related to the progress of the task, the screen being displayed by the browser software of the one of the progress management terminals, and
the issue that the progress is updated is reflected on other one or ones of the progress management terminals displaying a same screen as that of the one of the progress management terminals using bidirectional communications.
